(19) United States
(12) Patent Application Publication
(10) Pub. No.: US 2009/0038315 A1
(43) Pub. Date: Feb. 12, 2009

(54) Ion pump and an electrochemical engine using same

(76) Inventor: Robert Paul Johnson, Glendale, AZ (US)

Correspondence Address: ROBERT JOHNSON, 4840 W. LAURIE LANE, GLENDALE, AZ, 85302, US

(21) Appl. No.: 12/006,419

(22) Filed: Jan. 2, 2008

Related U.S. Application Data
(60) Provisional application No. 60/963,500, filed on Aug. 6, 2007.

(51) Int. Cl. C25B 15/00; C25B 9/04; F02C 7/00

(52) U.S. Cl. 60/783; 204/520; 204/450; 204/630

(57) ABSTRACT

An ion pump that generates a stream of unbalanced aqueous anions that transit from a cathode surface to a region adjacent to an anode surface. The ion pump works in conjunction with an ultrasound generator that produces standing waves having the intensity to dehydrogenate liquid hydrocarbons at the catalytic anode surface. Current density of the ion pump and frequency of the ultrasound transducer are synchronized according to the rate hydrogen permeates through a membrane. An electrochemical engine uses ion pumps and ultrasound generators to convert liquid hydrocarbon fuel to useful work while recovering hydrogen-depleted carbon from the fuel for recycling, including production of renewable fuel. When carbon is recovered, carbon dioxide is not produced. Tensile stress applied to the ion-pump membranes by rotation, high-frequency pressure waves, and radial acceleration of the interstitial hydrogen are applied in a collective manner that facilitates hydrogen permeation through the ion pump membranes.

### CROSS-REFERENCE TO RELATED APPLICATIONS

This application claims priority of provisional patent application Ser. No. 60/963,500 filed Aug. 6, 2007.

### FEDERALLY SPONSORED RESEARCH

Not Applicable

### SEQUENCE LISTING

Not Applicable

### BACKGROUND OF THE INVENTION

1. Field of Invention

This invention is an electrically charged and work activated electrochemical device. The device is disclosed as part of an electrochemical engine that simultaneously produces electricity and mechanical work by dehydrogenating liquid-hydrocarbon fuel.

2. Description of Prior Art

Fuel cells are well known. Fuels cells have provided electricity and drinking water for manned spacecraft for years. The automotive industry has interest in hydrogen-gas, and gasoline-reformer fuel cells for transportation. A hydrogen-economy infrastructure to support widespread use of hydrogen-gas-fueled PEM fuel-cell vehicles is virtually nonexistent. Although the efficiency of hydrogen-fueled fuel cells is high compared to the limits of the Carnot cycle, pressurized hydrogen gas is difficult to store in quantities that yield a convenient driving range. Metal hydride storage rapidly deteriorates with use. Fuel-cell stacks are heavy and the electrode materials are expensive. Gasoline-reformer fuel cells emit carbon dioxide gas. Concern over global warming and a desire to reduce greenhouse gases, such as carbon dioxide, favor a shift from hydrocarbon fuels. Most vehicles use unpressurized liquid fuel, which use low-cost onboard fuel storage and yield a convenient driving range between refueling. Modern engines have low emissions. Internal combustion engines can use a variety of fuels including gasoline, pressurized natural gas, ethanol, and cooking oils. All such fuels produce substantial carbon dioxide gas. Internal combustion engines can also use hydrogen as a fuel, and like fuel cells, the exhaust product is largely water vapor, which can be condensed and recycled. Fuel efficient engine developments include hybrid engines, where internal combustion engines and electric motors and generators are linked, and operate together to optimize the production of useful work from liquid hydrocarbons. Rising oil prices and growing concerns about global warming are the primary stimulants to evolve toward a hydrogen economy. Considerable effort has been devoted to improving fuel cells.

Electromechanical linkages have been proposed for fuel cells. U.S. Pat. Nos. 3,972,371ⁱ, 3,976,507ⁱⁱ, 4,001,041ⁱⁱⁱ, and 4,128,700^{iv} teach expanding hot cathode gases through a turbine to compress air supplied to the fuel cells or for any other suitable purpose. U.S. Pat. No. 6,887,609 B2^{v} teaches adding an excess of hydrogen gas to the anode and combining that excess with cathode gas to derive useful mechanical work through catalyzed expansion of the combined gas streams. i United States Patent, Aug. 3, 1976, Bloomfield et at.ii United States Patent, Aug. 24, 1976, D. P. Bloomfieldiii United States Patent, Jan. 4, 1977, M. C. Menardiv United States Patent, Dec. 5, 1976, R. A. Sederquistv United States Patent, May 3, 2005, L. Kaufmann

U.S. Pat. No. 5,614,332^{vi} claimed the use of any static or time-varying force, compressive, torque or tension force, acoustic or shock wave to at least one electrode to plastically deform the same to increase the charging and discharging efficiency of a battery. vi United States Patent, March 1997, Pavelle et at.

Pressure waves have been used as a means to increase the operating efficiency of electrochemical cells. U.S. Pat. No. 3,242,010^{vii} claimed improvements from sonic vibrations that increase the reactions between electrodes, electrolyte, and fuel or oxidizer phases of a fuel cell. U.S. Pat. No. 3,313,656^{viii} claimed the use of ultrasound to finely mix fuel and electrolyte. vii United States Patent, March 1966, A. G. Bodineviii United States Patent, April 1967, E. A. Blomgren et al.

Electrical and magnetic means of increasing reaction efficiency have been disclosed. U.S. Pat. No. 5,141,604^{ix} claimed the use of electrical biasing of permeable electrodes to more efficiently absorb, transmit, and desorb mobile atoms including hydrogen. Electrical potentials were directly applied to electrodes. The device is used for hydrogenation and dehydrogenation reactions. U.S. Pat. No. 3,436,271^{x} claimed the practice of periodically passing an electrical current through a cell in the direction of cell operation to improve performance. U.S. Pat. NO. 3,493,436^{xi} claimed the use of a magnetic field to generate magnified energy combinations that augment ion velocities and stimulate electrochemical activity. That patent also claimed aligning the lines of force of a magnetic field with the direction of movement of migrating ions. U.S. Pat. No. 3,751,302^{xii} claimed secondary electrodes in a fuel chamber connected to primary electrodes in an oxidant chamber, and secondary electrodes in an oxidant chamber connected to primary electrodes in a fuel chamber that enhance ionic transport between the primary and secondary electrode portions. ix United States Patent, Aug. 25, 1992, W. M. Ayersx United States Patent, Apr. 1, 1969, D. F. Cole et al.xi United States Patent, Feb. 3, 1970, C. I. Johnsenxii U.S. Pat. No. 3,751,302, Aug. 7, 1973, C. I. Johnsen.

Rotation has been claimed as a means of increasing the performance of electrochemical cells. U.S. Pat. No. 4,684,585^{xiii} employs rotation to centrifuge electrolyte within a spinning array of cells. U.S. Pat. No. 6,379,828 B1^{xiiv} claimed to improve the performance of one or more fuel cells by using rotation to mix, concentrate and circulate electrolytes, oxidants and fuel, and induce the flow of one substance through another of greater density through enhanced buoyancy. Previously mentioned U.S. Pat. No. 3,751,302 used rotation of a fuel cell device to produce oscillating electric pulsations. xiii United States Patent, Aug. 4, 1987, P. J. Tamminenxiv United States Patent, Apr. 30, 2002, B. Worth

### SUMMARY OF THE INVENTION

The first objective of this invention is to replace the fuel cells of prior art with the higher activity of ion pumps. An ion pump is an electrically charged device that can produce electricity in a manner similar to fuel cells, but does so by generating unbalanced anions and applying one or more forces that cause the anions to transit from a cathodic membrane to a region near an anodic membrane. Ion pumps produce surface charges of unbalanced anions near to, but not in direct contact with the anode surface. A regulated supply of unbalanced anions increases the activity of ion pumps. Ion pumps use overpotential and water as the source of anions.

A second objective is to combine the ion pump with an ultrasound wave generator that produces high-frequency pressure waves that dehydrogenate liquid hydrocarbon fuel at a catalytic surface. Ultrasound wave frequency and wave intensity, and the ionic current in the ion pump can be synchronized to the maximum sustainable rate that hydrogen permeates through the metal-electrode membranes of the ion pump. The ultrasonic pressure waves activate the ion pump.

A third objective is to incorporate ion pumps and the ultrasound generators into a rotating, gas expansion device that uses catalyzed, hydrogen and oxygen reactions to produce a turning torque. Rotation facilitates hydrogen permeation through the metal-electrode membranes of the ion pumps. Rotation turns a generator that charges the ion pumps and powers the ultrasound generator. The electrochemical engine consumes liquid hydrocarbon fuel, but produces little to no pollution or carbon-dioxide gas emissions. Residual hydrogen-depleted carbon, a fuel byproduct, is collected for reuse, including production of renewable, liquid hydrocarbon fuel that is easily and inexpensively stored. Electricity and turning torque are produced by the engine.

The ion pump is a closed vessel having an arrangement of false anodes disposed between two membranous electrode plates. One plate functions as an anode, and the second functions as a cathode. The anode and cathode are clad with a catalyzing material, such as a platinum-group metal, that is selectively permeable to hydrogen. A non-conducting frame separates and holds the electrode plates around the perimeters thereof. The dielectric frame and electrode plates form a closed vessel. The dielectric frame holds an arrangement of false anodes in position within the interior between the electrode plates. Each false anode presents greater surface area facing the cathode than that facing the anode. A cross-section through a false anode resembles a parabolic curve with the vertex nearest the cathode. Each false anode is electrically and chemically isolated except where a common bus bar passes through the dielectric frame and provides for electrical connection to external circuits. Water fills voids between the insulated false anodes, anode, cathode, and ion-pump frame.

An ultrasound device abuts the dielectric frame of the ion pump. The ultrasound device includes a transducer, a flexible diaphragm, and vibrator surface. The exterior surface of the ion-pump anode forms one wall of a narrow void between the ultrasound device and the ion pump. The flexible diaphragm and vibrator surface close the cavity opposite from the anode surface, and the dielectric frame closes the cavity along the remaining boundaries. The perimeter of the flexible diaphragm is secured between opposing mating surfaces of the ion-pump frame and ultrasound transducer housing. Together, the ultrasound device and ion pump form an activation cell. Liquid fuel fills the cavity and ultrasonic waves dehydrogenate hydrocarbons at the catalyzing anode surface.

An ion pump and ultrasound assembly can have various shapes including rectilinear, curved, or annular. The activation cells described herein resemble arc-segments of a cylinder. They are part of an electrochemical engine. Each ultrasound and ion pump assembly is radially aligned, outwardly. Several such radially aligned cells are circularly arrayed about a spin axis. Spoke walls radiating from an axle hub form a rotor frame that separates and secures the circularly arrayed cells. End flanges and a retainer ring hold the activation cells in place in the rotor frame. The axle shaft is hollow and forms a spinning, fuel inlet reservoir. An array of small galleys transfer fuel outwardly from the base of the hollow axle to the fuel cavities disposed within the activation cells. A second array of galleys runs radially inward from the tops of the fuel cavities to remove air and other gases. Rotation propels fuel outward into the fuel vessels in the activation cells, where it swirls against the anode surface. The rotating assemblage is cylindrical in form.

Work activates the electrode processes. At startup, electrons are transferred from the false anodes of the ion pump to the cathode. An electric field extends between the insulated false anodes and the cathode, and negative charge develops on the interior surface of the cathode. Negative charge at the cathode reduces water in the ion pumps as hydrogen is absorbed by the membranous electrode, thereby producing unbalanced hydroxide ions that migrate toward and surround the encapsulated false anodes.

Electrical attraction to false anode surface draws anions toward the anode surface. Anion density increases with migration, creating a localized negative surface charge near the anode. Inside the fuel vessel, ultrasonic waves, having a half-wavelength multiple that is equal to the radial depth of the fuel vessel, produce pressure waves that impinge against the anode surface. Superposition of negative charge within the ion pump and hydrogen bonding at the opposite, inner-radius surface of the anode cause conduction electrons of the anode to shift toward the fuel vessel. Energy appears at the anode surface at a frequency above the crystalline lattice single-site, hydrogen absorption rate of the membrane. Ultrasound waves and centrifugal pressure have maximum energy at the anode surface. Differing wave velocities through liquid and solid mediums produce cavitation. Anions within the ion-pump are agitated by cavitation and weakly held anions percolate toward the anode surface. Pressure and charge break the hydrogen-carbon bonds and draw hydrogen into the membranous electrode.

Hydrogen diffuses to the interior anode surface where unbalanced anions are favorably oxidized. Exothermic energy is released, raising the internal energy of the water in the ion pump. Electrical bias at the surface of the anode holds the extra electron, which shifts toward the cathode due to electrical attraction to the false anodes, which have greater surface area facing the cathode and lower surrounding anion density in that region. Increased internal energy, centrifugal pressure, and negative bias at the cathode surface reduces water and absorbs hydrogen into the electrode, and newly formed unbalanced anions are drawn by the false anodes toward the anode.

An axial-flow fan encircles the ion pumps and channels air to a gas expansion device to produce work. Venturi flow reduces pressure inside narrow, annular plenums disposed between the fan and the exterior cathode surfaces of the ion-pumps. Low pressure draws hydrogen from the cathode and into the energized airflow. Hydrogen gas and atmospheric oxygen catalytically react in tangential, divergent-flow nozzles and produce high-velocity thrust. Thrust produces a turning torque that causes rotation. Part of the turning torque energizes air entering the axial-flow fan. Rotation produces tensile stress in the anodic and cathodic membranes of the ion pump. Tensile stress, ultrasonic pressure waves, and radial acceleration increase the rate hydrogen permeates through the membranes. Hydrogen-depleted carbon accumulates in radial sumps below the ion pumps. Solenoid-actuated valves open ports through which the fuel byproduct is ejected into a collection reservoir. Thrust turns an electric generator. Electricity powers the ultrasound waves that dehydrogenate the fuel, charges the false anodes, and activates the solenoid-actuated valves. An electric motor provides startup rotation. A transitioning, variable-load motor-generator might be used for both startup and generation. Engine circuitry can be arranged in a variety of ways and onboard switching might vary the current and voltage output of the ion pumps.

Assuming heptane as a standard fuel, idealized chemical reactions are,

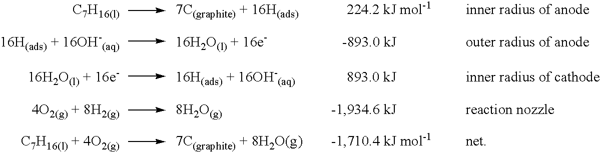

The net enthalpy of formation is −1,710.4 kJ per mole of fuel^{xv}. This compares to an enthalpy of combustion of −4,817.0 kJ mol⁻¹ when burning heptane in pure oxygen^{xvi}. However, reversible electrode reactions cause 16 electrons per C₇H₁₆ molecule to move through external conductors. Oxidation of anions at the anode is favored. The standard potential is 0.8277 volts^{xvii}. Energy to atomically free hydrogen is high: 3,712.2 kJ mol⁻¹ for heptane. Freeing hydrogen as a gas is unwanted. Instead, the aim is dehydrogenation at the catalytic anode surface, so hydrogen atoms can be absorbed into the metal. The ideal, anode mechanisms are as follows and high activation energy is required for the initial dehydrogenation at the anode:

C₇H_{16(I)}+16 vacant sites→7C (graphite)+16H_{(ads)} at the anode inner-radius surface

16H_{(ads)}→16H_{(abs)}+16 vacant sites at the metallic surface monolayer

16H_{(ads)}+16OH⁻_{(aq)}→16H₂O+16e⁻ at the anode outer-radius surface

xv CRC Handbook of Chemistry and Physics, 82^{nd} Edition, p. 5-1, 2, 3 and , 50xvi CRC Handbook of Chemistry and Physics, 82^{nd} Edition, p. 5-89xvii CRC Handbook of Chemistry and Physics, 82^{nd} Edition, p. 8-24

Using heptane as the fuel, a molar flow is approximated using comparative performance. A consumption rate of 30 miles per gallon, at 60 miles per hour uses about 1.466×10⁻² moles per second of fuel. For heptane fuel, this approximation is low due to the higher hydrogen content of predominantly octane fuel, so the pro forma fuel flow is factored upward by the hydrogen ratio. This yields a conceptual-design fuel-consumption-rate of about 1.65×10⁻² moles per second.

Decomposition of hydrocarbons on catalytic surfaces of the platinum group is known^{xviii}. Nickel has strong affinity for hydrogen and dehydrogenates alcohol^{xix}. Activation energy for the decomposition of methane drops from 330 kJ mol⁻¹ to 230-250 kJ mol⁻¹ in the presence of a platinum surface. The Gibbs equation predicts entropy driven decomposition of progressively longer alkanes to hydrogen gas and carbon at progressively lower temperatures. Activation energy for dehydrogenation of heptane is approximated by multiplying the standard enthalpy of formation of heptane, by the ratio of the activation energy to decompose methane to the standard enthalpy of formation of methane. Activation energy required to dehydrogenate heptane should be about 941 kJ mol⁻¹. That is less than the sum of the standard endothermic enthalpies of formation of the idealized reactions, or 1,117.24 kJ mol⁻¹. A hydrogen-sticky catalytic surface such as palladium will lower the activation energy. Since most activation energy reappears in the ion pump as hydrogen and hydroxide ions combine, energy added to dehydrogenate the fuel that equals the sum of the standard enthalpies yields an efficient full usage of the activation energy input. xviii M. Eisenberg, Fuel Cells 1963 edited by Will Mitchell Jr., p. 53xix Gilbert W. Castellan, Physical Chemistry, 3^{rd} Edition, p. 873

When hydrogen reacts with the anions in the ion pump, energy is released, heating the water near the anode. Energy released near the anode is absorbed by the water, the anode, and the fuel at the opposite anode surface. Most of the energy will be absorbed by the water where hydrogen reacts with OH⁻ ions. Water has a constant-pressure heat capacity of 75.3 J mol⁻¹ K⁻¹. Heptane has a higher constant-pressure heat capacity of 224.7 J mol⁻¹ K⁻¹. There is, however, a greater volume of water near the anode, into which the energy is transferred. The embodiment presented herein holds about 190 moles of water within the ion pumps, compared to 0.90 moles of fuel in the fuel vessels. The fuel flow is small. Heat absorbed by the anode aids permeation.

Hydroxide ions are the charge carriers. Sixteen moles of anions are produced for each mole of heptane consumed. The number of unbalanced anions is small in comparison to the water volume. Within the ion pumps, water flows from the anodes to the cathodes as OH⁻ flows from the cathodes to the anodes. The outward flow of water equals the inward flow of anions. Anions are drawn radially inward by electrically and chemically isolated false anodes.

False anodes are encapsulated in an insulating material having a low dielectric constant but high dielectric strength, and no reactivity to hydroxide ions. Polytetrafluoroethylene, PTFE is one such material. A very high dielectric-strength insulator might be added between the false anode and outer insulation to avoid electrical breakdown at high operating voltages. Each ion pump has a vertical array of false anodes. The upper and lower exterior surfaces of the encapsulating insulation of adjacent false anodes do not touch, leaving a void between adjacent false anodes of the vertical array. Water fills the voids. Each false anode has a vertical cross-section resembling a parabola with the vertex pointing toward the cathode. Unlike a parabola, a false anode can have straight leg-segments radiating from curvature around the vertex. Each encapsulated false anode lies about midway between the cathode and anode. Curvature around the parabolic vertex yields greater surface area than the sum of the termini of the two legs that radiate from the curvature. Curvature around the vertex can be varied, to increase the surface area facing the cathode. A circular arc segment is used in the presented embodiment. Viewed in cross-section, the surrounding insulation progressively thins, relative to the surface of the legs of each false anode, in the direction toward the anode. Electrons are removed from the false anodes and added to the cathode where water is first reduced to hydroxide ions. Attraction between unlike charges on the false anodes and the cathode concentrate the charges along the opposing surfaces. Negative overpotential on the cathode surface produces hydroxide ions. Positive charge around the curvature of the false anodes attracts the unbalanced anions forming at the cathode surface. Mobile anions migrate to the surface of the insulation.

The attractive force between the mobile anions and the fixed false anodes is in the direction toward the surface of the false anodes. A vector representing the attracting force can be resolved into normal vector components. One of the vector components is along the exterior surface of the insulation and is generally in the direction of the ion-pump anode. This vector component acts on the anions until they are nearest the false anode surface. Centrifugally induced buoyancy might favor the direction of anion migration. Insulation having a low dielectric constant reduces interaction with the anions, which might impede the migration. Insulation surrounding a false anode is thickest around the vertex. Anions migrate closer to the false anode surface. Positive charge initially concentrated around the vertex follows the mobile anions as they move along the insulation surface. Migrating anions shield the positive charge on adjacent false anodes, which allows positive charge to spread across the false-anode.

The surface area of the false anode is smaller than that of the insulation. Anion density around the vertex end of the false anode is lowest where the separation between unlike charges is greatest. Anion density near the anode end of the false anode is greatest where the separation of unlike charges is smallest. Fringing at the inner-radius termini of the false-anode legs draws anions into a narrow gap between the inner-radius, exterior surface of the false-anode insulation and the outer-radius, interior surface of the ion-pump anode. There, the radially inward drift velocity is zero. The two surfaces forming the narrow gap are about parallel, with the exception of a thin protruding ridge of insulation. This protrusion extends across the gap from the insulation to the anode surface. The narrow insulation bridge vertically traps hydrogen gas formations inside the ion pump, transmits vibration from the anode into the ion pump, which agitates ions at the insulation surface, and adds support to the ion-pump anode.

For each mole of fuel dehydrogenated, 16 moles, or 0.2639 mol s⁻¹, of water are reduced. A flow of 0.2639 mol s⁻¹ yields an ion current of 25,463 Amperes. Current density, J, equals (ne)v_{d}, where (ne) is the charge per unit volume, or C m⁻³. Increasing drift velocity reduces the molarity. An estimated drift velocity of ions in aqueous solution can be determined in two ways. Both methods are a function of an electric field, E. By Stokes' law, drift velocity, v_{d}, equals eE/6πηr^{xx}. From Coulomb's law eE is the electric force attracting the anions to the false anodes and in the direction of the anode, η is the viscosity of water and r is the spherical radius of the anions. For determining drift velocity, the electrical force is the vector component acting along the insulation surface, and depends on the angle between the false anode and insulation surfaces, viewed in cross-section. Drift velocity is also a function of conductivity. Conductivity, σ, is the inverse of resistivity and is the ratio of current density and the electric field, or J/E. The drift velocity equals σE/ne. Conductivity of OH⁻¹ in an infinitely dilute solution is 0.01983 S m² mol^{-1 xxi}. High OH⁻¹ conductivity is attributed to proton exchange and is unaffected by viscosity^{xxii}. A 25,463 Ampere, OH⁻¹ current might require a high electrical potential to produce a high drift velocity along the insulation surface. Electrical attraction pulls unbalanced hydroxide ions to the surface of the insulation encapsulating the false anodes. Anions travel along the insulation surface and do not form a uniform, aqueous electrolyte. Antifreeze or another solution might be added to the water so long as the addition supports, or otherwise does not disrupt operation of the ion pump. Centrifuging the water might lower the required voltage. xx Gilbert W. Castellan, Physical Chemistry, 3^{rd} Edition, p. 781xxi CRC Handbook of Chemistry and Physics, 82^{nd} Edition, p. 5-96xxii Gilbert W. Castellan, Physical Chemistry, 3^{rd} Edition, p. 783

During steady-state operation, the internal energy of the water inside the ion pumps increases when hydrogen combines with the OH⁻ anions. Temperature and pressure increase. Anions disappear as hydrogen ions enter the water and electrons are left at the anode. Electrical balance between the false anodes and the unbalanced anions is upset. Anionic surface-charge-density decreases near the anode. Anions continue to migrate toward the anode to move closer to the false anode surfaces. Higher surface density of anions near the anode better shields the false anodes in that region. There is greater positive charge on the false anodes than there is negative charge on the remaining surrounding anions. Left partially unshielded, some positive charge moves back toward the vertices of the false anodes. Electrons left on the ion-pump anode are attracted to the cathode to balance the redistributed, steady state electric field of the false anodes. According to the Le Chatelier principle, an endothermic shift to a new equilibrium is favored. Autoionization of the water replaces the anions. Autoionization follows Maxwell's distribution of energy. At 323 K, 9.19×10⁻⁷ moles, of 189.7 moles of water within the ion pumps, have the requisite 92.7×10⁻²¹ Joules per molecule to autoionize to OH⁻ and H⁺ at any moment. Kinetic energy is converted into electric potential. As water ionizes near the negatively biased cathode surface, H⁺ is absorbed into the cathodic membrane, leaving an unbalanced anion, which migrates toward the false anodes. Heat released when H⁺ combined with OH⁻ near the ion-pump anode helps replenish electrically balancing OH⁻ anions at the cathode.

Multiple ion pumps form an annular ring around the axis-of-rotation. Ion pumps are closed systems. Reduction of water at the cathode surface is, in part, pressure driven. Enthalpy can be supplied by pressure. Enthalpy is defined as the sum of internal energy and the product of pressure and volume, or H≡U+pV. It follows that dH=dU+(p)dV+(V)dp. The ion-pump volume is fixed, so (p)dV≈0 and ΔH=Q+(Δp)V, where Δp is force applied to a surface area, or F/A. Under centripetal acceleration Fᵣ=mω²R, where m is the mass, o is angular speed, and R is the distance from the spin axis. The pressure-containing cathode surface, A, is normal to the force. The product, (Δp)V, becomes m(Δω)²R(I), where, I is the radial depth. A rotating mass gains rotational kinetic energy as it moves radially outward from the spin axis. Increasing kinetic energy increases pressure. Dividing I by the time to travel that distance determines the rate enthalpy is added to the fluid. Radial depth I equals r, so dH₍ₚᵥ₎/dt=mω²r dr/dt. If the angular acceleration is zero, then the angular speed o is constant, and ΔH=½m(ωΔr)², which is rotational kinetic energy. The radial, fluid depth inside each ion pump is small when compared to the radial distance to the spin axis. If rotational kinetic energy were the sole source of enthalpy to reduce water, the angular speed and/or design radius of the cathode surface might be very large. Most enthalpy for the reduction of water at the cathode surface comes from the change in the internal energy of the water and the electric potential of the cathode.

The embodiment presented requires a H₂ (STP) permeation rate of about 67 milliliters per minute per square centimeter. Increasing the vertical dimensions of the ion pumps would reduce the permeation rate by increasing membrane surface area. Increasing the vertical dimension without increasing the fluid volume of the ion pumps increases the angle of the legs of the false anodes to the radial plane through its parabolic axis. Increasing the angle of the legs of the false anode increases the radially inward directed force vector component acting on the anions. Those are positive changes. The utility and economy of a smaller overall engine size is also an important design consideration, so maximizing H₂ permeation is a rational design goal. High H₂ permeation could saturate a membrane with hydrogen. Over time, hydrogen saturation of the membrane will cause embrittlement and structural failure. Palladium, vanadium, and niobium are known hydrogen membranes. Vanadium and niobium have bcc crystalline structures. In most bcc and hcp metals, there is a risk of hydrogen embrittlement^{xxiii}. Metal hydrides might precipitate with decreasing temperature. Near room temperature, the concentration of H/Nb at the solubility limit of the α phase is between 10⁻² and 10^{-1 xxiv}. Once absorbed into the metallic membrane, the interstitial mobility of hydrogen is high. In the temperature range from 25 to 75° C., the mean-time-of-stay is about 1×10⁻⁹ s in palladium and about 1×10⁻¹¹ s in niobium^{xxv}. The answer to high rate of hydrogen permeation without a high hydrogen concentration and saturation is unidirectional movement of hydrogen through the metal. xxiii George E. Dieter, Mechanical Metallurgy, 3^{rd} Edition, p. 490xxiv T Schober and H. Wenzl, Topics in Applied Physics, Hydrogen in Metals II, p. 33, FIG. 2.19xxv J. Völkl and G. Alefeld, Topics in Applied Physics, Hydrogen in Metals I, p. 325, FIG. 12.2, p. 330, FIG. 12.5

High-intensity pressure waves, heat, catalysis, and radial acceleration dehydrogenate the hydrocarbon at the anode. A favorable surface bias supports rapid absorption of hydrogen into the membrane. Tensile stress across a thin-wall membrane surface, high-frequency pressure waves propagating through the metallic lattice and high radial acceleration, which increases with radius, propel hydrogen atoms through the membrane.

Ultrasound waves are produced by transducers that vibrate a rigid surface lying parallel to the anode surface. The distance separating the ion-pump anode surface and the vibrating surface is related to the wavelength of a longitudinal pressure wave. Wave frequency is a function of the rate at which hydrogen is absorbed into the ion-pump membranes. The maximum permeation rate determines the minimum, membrane surface area required for hydrogen diffusion through the membrane. The minimum wave frequency equals the number of hydrogen atoms that must enter the interstices of each crystalline cube at the metal surface. At this minimum, one hydrogen atom must enter each available cubic crystal with each pulse. That would require a contemporaneous expansion of the entire electrode surface. It would also require that hydrogen atoms on the carbon chain favorably align with the crystals of the electrode surface. Neither condition is likely to occur so conveniently. Instead, the frequency is a multiple of the required single-site permeation rate. The higher the multiple, the more likely hydrogen will be absorbed at the desired rate. Velocity of a sound wave through a medium equals the product of the frequency and wavelength, or v=fλ. Wave velocity through a medium is also a function of the compressibility and density of a medium, or v=(B/ρ)^{1/2}, where B is the bulk modulus of the medium and ρ is its density. For heptane fuel, at 20° C., the velocity of sound is about 1,138.4 m s⁻¹. At a frequency of 904.19 kHz, a pressure wave traveling through the liquid has a wavelength of 1.259 millimeters. The frequency is 10 times the desired hydrogen absorption rate per crystalline cube. This results in a minimum half-wavelength separation of the vibrating plate and anode surface of 0.6295 millimeters. Separations equal to integer multiples of a half wavelength might produce a standing wave that builds in intensity. A wavelength of 1.0 millimeter has a frequency of 1.138 MHz, or 12.6 times the absorption rate. Minimizing the plate separation to a half wavelength has the added safety of limiting the volume of fuel spinning at high angular speed to about 0.13 liters. Using a separation of 0.5 millimeter and two wavelengths of 0.25 millimeters yields a corresponding frequency of 4.553 MHz, or 50.36 times the desired hydrogen absorption rate. This is within the frequency range of both piezoelectric and magnetostriction-driven, ultrasound transducers. X-cut quartz crystals and magnetostriction-type transducers are used to produce longitudinal waves in liquids^{xxvi}. Compressive vibrations of transducer plates occurs at higher frequencies^{xxvii}. xxvi McGraw-Hill Encyclopedia of Physics, 2^{nd} Edition, p. 1480xxvii McGraw-Hill Encyclopedia of Physics, 2^{nd} Edition, p. 1036

In octane, the velocity of sound is 1,174.1 m s⁻¹. Retaining a desired wavelength, the frequency increases, which is desirable since the opportunities to absorb more hydrogen into the electrode increases. Having the ability to use either fuel requires two oscillator frequencies. Activation energy to dehydrogenate octane should be near 1,050 kJ mol⁻¹, and the sum of the standard endothermic enthalpies is 1,254.77 kJ mol⁻¹. The sum of the endothermic enthalpies for heptane and octane are greater than the estimated activation energy to dehydrogenate the fuels. Wave intensity supplies the activation energy.

Wave intensity is the average rate per unit area at which power is transmitted by the wave^{xxviii}. It is measured in watts per square meter, W m⁻². The intensity of a sound wave through a medium is given by I=½ρvω²sₘ², where ω=2πf, and sₘ is the maximum displacement amplitude. Since frequency is governed by the rate hydrogen is absorbed by the membrane, pressure amplitude modulates the activation energy. Displacement amplitude is related to pressure amplitude, and maximum pressure and energy occur at displacement nodes. Pressure varies with frequency and the strain of the crystal or ferroelectric material. Strain is produced by, and is proportional to a polarizing electric field. Strain is greater in an oscillating field than in a static field. Wave velocity is fixed by the compressibility of the medium. The average velocity of the vibrator plate surface is the product of frequency and electric-field-induced displacement. At the ends of the travel, the velocity is zero. Changing velocity is acceleration, and pressure varies with acceleration. Angular speed and standing waves increase the wave intensity at the anode surface, which is catalytic. xxviii Halliday, Resnick and Walker, Fundamentals of Physics, 4^{th} Edition, p. 510

Longitudinal waves travel generally normal to the surface of the vibrating plate. Increasing shear will occur away from the centerline of the curved plate. Shearing motion lowers the wave intensity, but heats the fuel. To limit shearing motion, each anode has an arc width of about 23 degrees. Each anode surface might have an array of smaller wave generators of smaller arc width.

Not all wave energy at the anode is reflected back to the vibrating plate. Energy passes through the anode. Wave velocity through the solid membrane is higher than through the liquid. The velocity change produces cavitation. The collapse of bubbles in a fluid during cavitation produces pressure that is used to catalyze chemical reactions^{xxix}. Cavitation occurs inside the ion pump. The narrow bridge that abuts the anode surface transmits the vibration of the anode into the insulation that surrounds the false anodes, and might amplify the vibration. xxix McGraw-Hill Encyclopedia of Physics, 2^{nd} Edition, p. 1483

Hydrogen adsorption and absorption are a function of bias on the anode. Saturated hydrocarbons are carbon chains wrapped with hydrogen. Carbon has an electronegativity of 2.55^{xxx}. Hydrogen has an electronegativity of 2.20^{xxxi}. C:H bonds are nearly covalent, so the higher electron density between the nuclei creates a slightly positive, but non-polar, potential surrounding the molecule. Attraction between the hydrocarbon molecules is the weak dispersion forces of induced-dipole, induced-dipole bonds of hydrogen. Evidence of this is the low density, surface tension, and boiling points of the molecularly heavy, liquid alkanes. The liquid fuel is accelerated against the anode surface. Hydrogen bonding on the fuel vessel surface of the anode shifts conducting electrons toward the inner-radius surface. Unbalanced anions surround the false anodes in the adjacent ion pumps. Anions that enter the narrow region between the insulation of the false anodes and the anode are held by the charge of the false anodes. By superposition, anions along the insulation surface are nearer the anode than the more distant false anodes. As an aggregate, the anions produce a negative surface charge. Disturbing the negative surface charge supports a shift of electrons at the anode surface. Cavitation and vibration at the anode and insulation surfaces agitates the fluid inside the ion pump. Agitated anions percolate radially inward toward the outer-radius surface of the anode. Inward movement of anions further amplifies the hydrogen bonding by pushing conduction electrons in the metal toward the fuel vessel. The anodes develop surface biases on opposing surfaces. On the fuel vessel side, the surface bias varies from zero to a negative potential. On the water reservoir side, the surface bias varies from zero to a positive potential. A very small, negative overpotential causes palladium to absorb a large volume of hydrogen. A positive bias on the opposite anode surface causes H⁺ to flow into an electrolyte solution^{xxxii}. Surface charge on the anode and hydrogen bonding destabilize the covalent bonds between the hydrogen and carbon nuclei. Activation energy dehydrogenates the hydrocarbon fuel at the anode surface, and the indirectly induced surface bias favorably draws hydrogen into the electrode metal. xxx CRC Handbook of Chemistry and Physics, 82^{nd} Edition, p. 9-75xxxi CRC Handbook of Chemistry and Physics, 82^{nd} Edition, p. 9-75xxxii Gilbert W. Castellan, Physical Chemistry, 3^{rd} Edition, p. 876

Hydrogen diffuses through the metals of both ion-pump electrodes. Fick's law for steady state diffusion is J=D (dc/dx), where J is the flux, D is the coefficient of diffusivity and dc/dx is the change in concentration in the direction of the gradient^{xxxiii}. The coefficient of diffusivity varies with temperature or D=Dₒe^{(-Ea/kT) xxxiv}. Heating the membrane metal increases interstitial mobility. Thermal energy increases bond lengths between adjacent atoms of the lattice, which causes expansion. Thermal energy also increases vibration in the bonds. The coefficient of diffusivity also varies with concentration; it decreases with increasing concentration. Increased interstitial concentration is unwanted. If hydrogen atoms move in a generally radial direction, the interstitial hydrogen concentration remains low. A short, radial-transit through a thin membrane results in a small hydrogen flux present within the lattice at any time. xxxiii Smith, Foundations of Materials Science and Engineering, 2^{nd} Edition, p. 160xxxiv J. Völkl and G. Alefeld, Topics in Applied Physics, Hydrogen in Metals I, p. 325

Flux is a function of directional forces and the mobility (mean-time-of-stay) of the hydrogen atoms in the interstices of the host^{xxxv}. Centrifugal force acts on all atoms within the membrane. The force vector is radial, acts at all interstices throughout the membrane, and increases with distance from the axis-of-rotation. Radial acceleration depends upon angular speed. At about 4,700 rpm, radial acceleration is 62.7 km s⁻² in the anode and 70.4 km s⁻² in the cathode. A diffusive force equal to 63 N mol⁻¹ acts on the hydrogen atoms in the anode, and a diffusive force of 71 N mol⁻¹ acts on the hydrogen atoms in the cathode. Cubic expansion occurs as hydrogen moves through a metallic lattice. Radial acceleration acting on the thin-wall membrane produces tensile stress that favors lateral expansion of the metal. The thin-walled membranes are in tension between the arc-sector ends, where the electrodes are secured to the ion-pump frame. Strain from top to bottom is also favored. A pressure wave traveling through the lattice produces a short-term compression of bond lengths in the radial direction and expansion of bond lengths in the lateral directions, as the wave moves past. Conversely, radially inward pressure against an arc compresses lattice bond lengths and increases resistance to interstitial movement. As the pressure wave passes, brief anisotropic flexure and radial acceleration expel interstitial hydrogen atoms in the radial direction. The velocity vector of the pressure wave is nearly aligned with centrifugal acceleration. Radial expulsion of the interstitial hydrogen atom is favored, yielding a greater unidirectional flux through the lattice than would occur in the more random movements of concentration-driven diffusion. When hydrogen atoms move in generally the same direction, interstices in the flux path will be largely unoccupied, and concentration-caused resistance to interstitial movement is reduced in that direction. xxxv H. Wipf, Topics in Applied Physics, Hydrogen in Metals III, p. 56

The region between each anode and the axis-of-rotation forms an arc sector. The fuel vessel is in this region. Each of the anodes inclines toward the axis-of-rotation with increasing elevation. The angle of incline ensures that denser hydrogen-depleted carbon byproducts, move downward to the base of the anode and into a sump. A vector component of centrifugal force and gravity combine to yield downward movement. Cavitation cleans the anode surface of carbon deposits that might result from dehydrogenation of the fuel.

Moving fluids through the engine requires work. The device has two mass flows: the fuel and air. The Euler turbomachine equation determines the torque for steady fluid flow. Work is the product of torque and angular displacement. Mechanical power is the product of ω (R₂Vₜ₂−R₁Vₜ₁) and the mass flow^{xxxvi}, where ω is angular speed, Vₜ is tangential velocity and R is radius. Work is added when the angular momentum of a fluid increases, and work is derived when the angular momentum of a fluid decreases. Centrifuged fuel byproduct is periodically ejected in the radial direction. Ideally, the work rate of the mass flow of heptane fuel consumes about 68.2 joules per second of available energy. Work to move the hydrogen component of the fuel from the anode to the outer cathode surface consumes about 2.3 J/s. xxxvi Fox & McDonald, Introduction to Fluid Mechanics, 5^{th} Edition, p. 498

Air is drawn into the electrochemical engine through an axial-flow fan that encircles the circular array of ion pumps. Air enters the fan near the top of the ion pumps. Airflow through the fan is treated as an incompressible fluid. The angle of the vanes is parallel to the axis-of-rotation near the base of the cathodes, thus increasing the energy of the airflow to that of the engine. Air exiting the fan flows through small inlet jets into tangential nozzles where oxygen in the air reacts with hydrogen exiting the cathodes. Power is the product of angular speed and torque, or ωT. The reaction produces thrust in the direction of rotation. Heated gas is converted to high velocity flow. The amount of energy produced depends on the completeness of the reaction within the nozzles. That depends upon the number of energetic collisions of hydrogen and oxygen gas molecules in the nozzle inlets. To that end, the airflow used in the presented embodiment is fifteen times the stoichiometric flow, or about 0.13683 kg/s. The air-to-fuel ratio will be determined by manufacturers of the electrochemical engine according to their needs. Reduced venturi pressure produced by the airflow, draws hydrogen gas from the cathode surfaces.

Evolving H₂ gas is segregated from the fan airflow by a narrow annular plenum. The outer-radius, cathode surface cladding is of the platinum group. Cathode-gas plenum chambers reduce the likelihood of an unintended reaction of hydrogen and oxygen at the cathode surface. The axial-flow fan surrounds the cathode-gas plenum. Airflow through the nozzle inlet jets passes across smaller, hydrogen inlets that merge into the nozzle inlets at an acute angle. Flow across the merging inlets is parallel to the area of the smaller openings. Pressure inside the smaller jets drops and draws H₂ gas from the adjoining plenum into the airflow where delayed mixing occurs. The outward draw reduces pressure within the segregated plenum chambers, and increases the pressure gradient across the cathode. The pressure gradient aids permeation of hydrogen through the cathode. The Euler turbomachine equation determines the ideal torque and work moving air through the device. Airflow through the engine consumes 6.52 kW of energy. About half of this work input is rotational kinetic energy added to the air. Rotational kinetic energy can be recovered as work output as the energized air-mass-flow turns to a direction that is anti-parallel to the engine rotation and the angular momentum of the fluid slows.

Complete dehydrogenation of the fuel flow produces 31.91 kJ s⁻¹ of chemical potential from the exothermic reaction of hydrogen and oxygen. Work can be produced by various gas-expansion devices including gas turbines, offset rotor devices, and pistons. This embodiment employs tangential-flow, divergent nozzles as a means of producing work. Tangential-flow, divergent nozzles are used because of the simplicity of a nozzle wheel. For 100% efficiency, the heated air-steam mix must have an exit velocity of 1,355 meters per second, relative to the nozzle, at a radius of 0.3365 meters. Alternate embodiments can use different angular speeds and radii.

An array of nozzles around a nozzle wheel results in a number of small, relatively short nozzle passages. Heat transfer and friction are insignificant. Isentropic equations for an ideal gas closely model the compressible flow. Pre-reaction velocity comes from the energized airflow from the axial-flow fan. From the first law of thermodynamics, exothermic enthalpy of the molar flow equates to a velocity potential of about 683 meters per second. At about 6,800 rpm, if all available energy is converted to velocity that is anti-parallel to the rotation of the nozzle wheel, the post-reaction, relative velocity of the mixed flow at the nozzle entrance is about Mach 1.91. The constant-pressure-heat-capacity of the air-steam mixture is 1031.2 J/kg·K and the gas constant is 292.3 J/(kg·K). Mach speed of a fluid flow and nozzle cross-sectional area are mathematically related^{xxxvii}. Nozzle area ratios are calculated relative to a nozzle throat where the threshold Mach speed is 1.0. If gas enters each nozzle at Mach 1.91, that establishes the beginning area-ratio. The exit velocity of the fluid flow determines the ending area-ratio. At 100% nozzle efficiency, the relative nozzle exit velocity is about Mach 2.87. A specific heat ratio, λ, of 1.397 yields beginning and ending area ratios of 1.573 and 3.747, respectively, for a nozzle area increase of 2.38 times. A continuum of intermediate area-ratios define the nozzle passage between the beginning and ending area-ratios. Beginning and ending pressure ratios are 0.147 and 0.033, for a pressure decrease of 77.3% at the exhaust. The reduced exhaust pressure exceeds ambient pressure. xxxvii Fox & McDonald, Introduction to Fluid Mechanics, 5^{th} Edition, p. 724

Electric induction circuits power the ultrasound transducers. Rigid wire loops pass between a circular array of magnets. Change in the area enclosed by the loops and within the magnetic flux, induces current^{xxxviii}. Work is required to move rigid wire loops past a magnet. The rate-of-work is equal to [B²(nL)²v²]R⁻¹, where B is the magnetic induction, n is the number of turns of the coil, L is the length of a coil side not parallel to the motion, v is the velocity of the motion and R is the resistance of the wire. Induced emf equals nBLv, and current is equal to E/R. Twelve induction circuits using six magnet pairs with an induction of 0.1025 T, eight windings having vertical lengths of 0.0508 m, and circuit resistance of 0.02 ohms, produce about 18,507 J/s of electrical power. This produces a wave intensity of 7.0125 W cm⁻², enough power to add 1,117.24 kJ mol⁻¹ s⁻¹ to the fuel accelerated against the anode surface. At a frequency of 4.553 MHz, the intensity requires a 14.84-nanometer displacement of the transducer surface. The generator might use electromagnets. By adjusting the current of electromagnets, the magnetic flux can be changed to produce the required electric power at different angular velocities. xxxviii Halliday, Resnick and Walker, Fundamentals of Physics, 4^{th} Edition, p. 881

Work is required to move smaller rigid wire loops past magnets. The smaller wire loops supply electrical charge of the false anodes. Twelve induction circuits using the same six 0.1025 T magnets and one winding with a vertical length of 0.0127 m and little circuit resistance consume about 15.1 J/s of available energy. Each circuit charges the false anodes of an ion pump in brief pulses. A short charging period can build to a high electric potential on the false anode that will yield a rapid anion transit through the ion-pump. Charge on the false anodes is constant. Once charged, this work requirement is unneeded. The electrical energy is then used to power exhaust valves and/or generate electrical output.

Work is also required to activate valves that eject the concentrated, hydrogen-depleted carbon byproduct. The valves are activated by solenoids that must overcome radial acceleration that acts on the valve stems. Valve movement is opposite the radial acceleration. Restoring springs close the valves when current is removed. To prevent fuel leakage, the restoring springs also hold the valves shut when the engine is not turning. The valves use counterweights to offset the high centrifugal force. A counterweight moves radially outward while the plunger and valve rod move inward. The force to overcome the spring constant is according to Hook's law, and is about 40 N at maximum and 5 N at minimum. The net pulling force remains close to five N throughout the valve movement. Power is a function of the speed at which the valves operate. Solenoids can operate in the millisecond range. A brief capacitive discharge will likely actuate the solenoid. The period and duty cycle depend on sump volume and exhaust port size. Volume flow rates and conceptual sump size allow a 65-second filling period in the presented embodiment. Each solenoid produces 10.0 N of pull, and is actuated for about 7 milliseconds. That yields a 0.01-percent duty cycle. Energy that is stored in the false anodes far exceeds that needed to actuate the solenoids. The false anodes are positively charged and the presented embodiment has a negative ground. Therefore, the false anodes could double as storage capacitors for the solenoid power supply. Alternatively, dedicated storage capacitors might be charged. Current for the solenoids, approximately 3.7 amperes per solenoid, favors on-board discharge circuits.

Two primary factors determine the overall efficiency of the pumped-ion electrochemical engine: the extent to which the fuel is dehydrogenated and the extent to which chemical energy is extracted as work. The first parameter determines the electrical energy produced by the ion pumps as well as the available chemical energy. The pro forma molar fuel flow contains about 21.07 kilowatts of standard free energy from electron transfer by the ion pumps. The hydrogen throughput has a maximum chemical potential of about 31.91 kilowatts from the hydrogen-oxygen reaction. Total dehydrogenation of the molar flow of heptane and attaining maximum nozzle thrust yields an ideal efficiency of about 32.628 percent. In addition to the described work inputs, the estimate assumes shaft losses from two anti-friction bearings and one large-radius, vapor-barrier bearing of 0.7 kW and 10% circuit losses due to heat dissipation of about 2.058 kW. That yields 25.92 kilowatts, or about 35 horsepower of constant output. This theoretical prediction assumes ideal energy input where the exothermic release of activation energy added to dehydrogenate the fuel, supplies the endothermic enthalpy needed to reduce water in the ion pumps. The prediction also assumes the kinetic energy added to the airflow by the fan is beneficially used.

### BRIEF DESCRIPTION OF THE DRAWINGS

The detailed description of the pumped-ion, electrochemical engine and the associated drawing figures begins with the assembled engine, and proceeds through disassembly revealing the interior elements of the design. The presented embodiment is exemplary and is not intended to preach a singular design. Relative size and shape of elements of the design might vary from that presented. It is the intent of the inventor that manufacturers have the flexibility to manipulate size, shapes, and other parameters to suit their own end-use goals.

FIG. 1 is an isometric view of the assembled pumped-ion, electrochemical engine.

FIG. 2 is an isometric view of the electrochemical engine with the exhaust manifold and engine cowling separated, and the fuel inlet and armature brush assemblies are separated.

FIG. 3 is an isometric view of the rotating assembly of the engine and the exhaust stator ring separated from the engine base.

FIG. 4 is an isometric view with the axial-flow fan, a knife-edge seal, and fan spacer separated from the rotating assembly.

FIG. 5 is an isometric view of the slip-ring retainer rings, cathode-gas plenum, and slip-ring plate separated from the rotor assembly. The slip rings are removed from the slip-ring plate.

FIG. 6 is an isometric view of the nozzle wheel separated from the rotor frame. One activation cell and one electronic control module are removed from the rotor frame.

FIG. 7 is an exploded isometric view of the components of the ultrasound transducer assembly and an isometric view of the ion pump, which together make one activation cell.

FIG. 8 is an exploded isometric view of the ultrasound transducer assembly from the opposite direction and below the radial plane of FIG. 7, showing details not visible in FIG. 7.

FIG. 9 is an enlarged cross-section of the ion pump.

FIG. 10 is an exploded view from below the radial plane of the nozzle wheel assembly, vapor-barrier bearing, junction board assemblies, and induction loop assembly.

FIG. 11 is an isometric view of the induction loop assembly, and FIG. 12 is a section view that exposes the induction loops embedded in the induction loop housing.

FIG. 13a and FIG. 13b are isometric views of the exhaust valve assembly from opposite ends of the valves.

FIG. 14 is an exploded, isometric view of the component parts of the exhaust valve assembly.

FIG. 15 is an isometric view of the nozzle wheel, and FIG. 16 is a section view of the lower portion of the nozzle wheel.

FIG. 17 is an isometric view of the exhaust stator ring, and FIG. 18 is a section view of the lower portion of the exhaust stator ring.

FIG. 19 is an isometric view of the rotor frame, and FIG. 20 is an isometric view from below the radial plane of the rotor frame.

FIG. 21 is an isometric view of the engine base, and FIG. 22 is a section view through the center of the engine base.

FIG. 23 is an isometric view of the engine cowling from below the radial plane, and FIG. 24 is a horizontal section view of the engine cowling.

FIG. 25 is an exploded view from below the radial plane of the components fuel inlet.

FIG. 26 is an exploded isometric view of the liquid/gas separator.

### DESCRIPTION OF THE PRESENTED EMBODIMENT

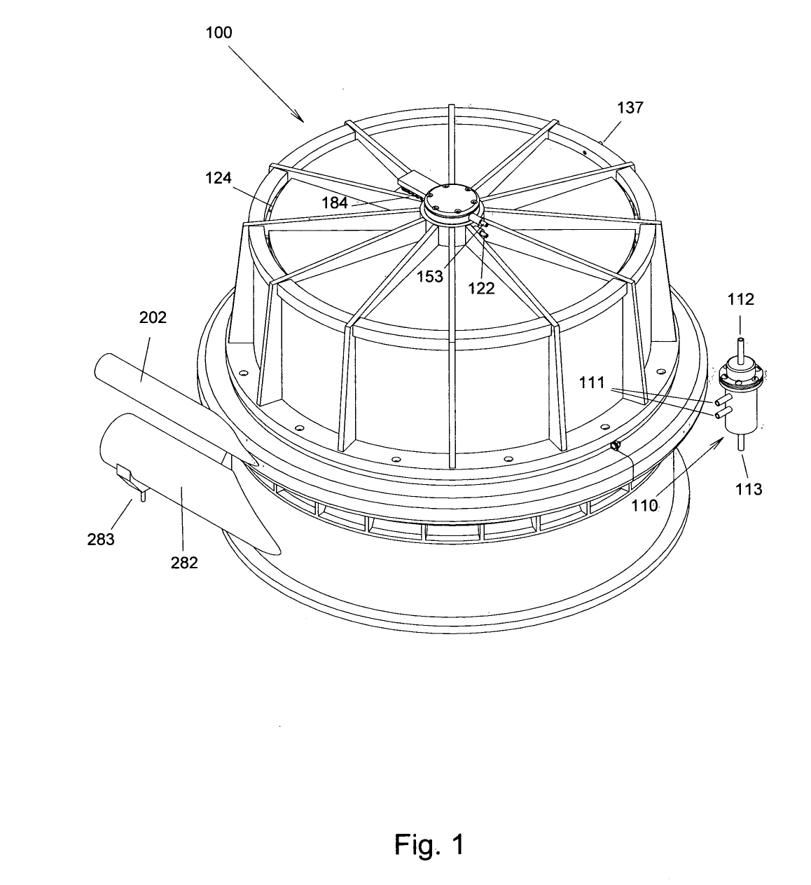

FIG. 1 is an isometric view of the electrochemical engine, 100. The electrochemical engine is generally cylindrical in form. Fuel enters the engine through fuel inlet ferrule, 153, near the top center of the electrochemical engine. Purged gas and fuel overflow are removed from the engine through a ferrule, 122. Purged gas and liquid fuel are separated in a liquid/gas separator, 110. Purged gas and liquid fuel enter the separator through inlet fittings, 111. Fuel exits through drain fitting, 113, at the base thereof. Purged gas exits through gas return fitting, 112. Purged gas is recirculated through gas return ferrule, 137, on the electrochemical engine. Air enters the engine through a circular array of arc-segment air inlets, 124. Steam exits through exhaust pipe, 202. Recovered fuel byproduct is periodically removed through byproduct-reservoir, clean out pipe, 282. A hose connects a drain fitting on byproduct reservoir drain, 283, to one of the two inlet fittings of the liquid/gas separator. Electrical connections are made through connectors, 184, located near the center and top of the engine.

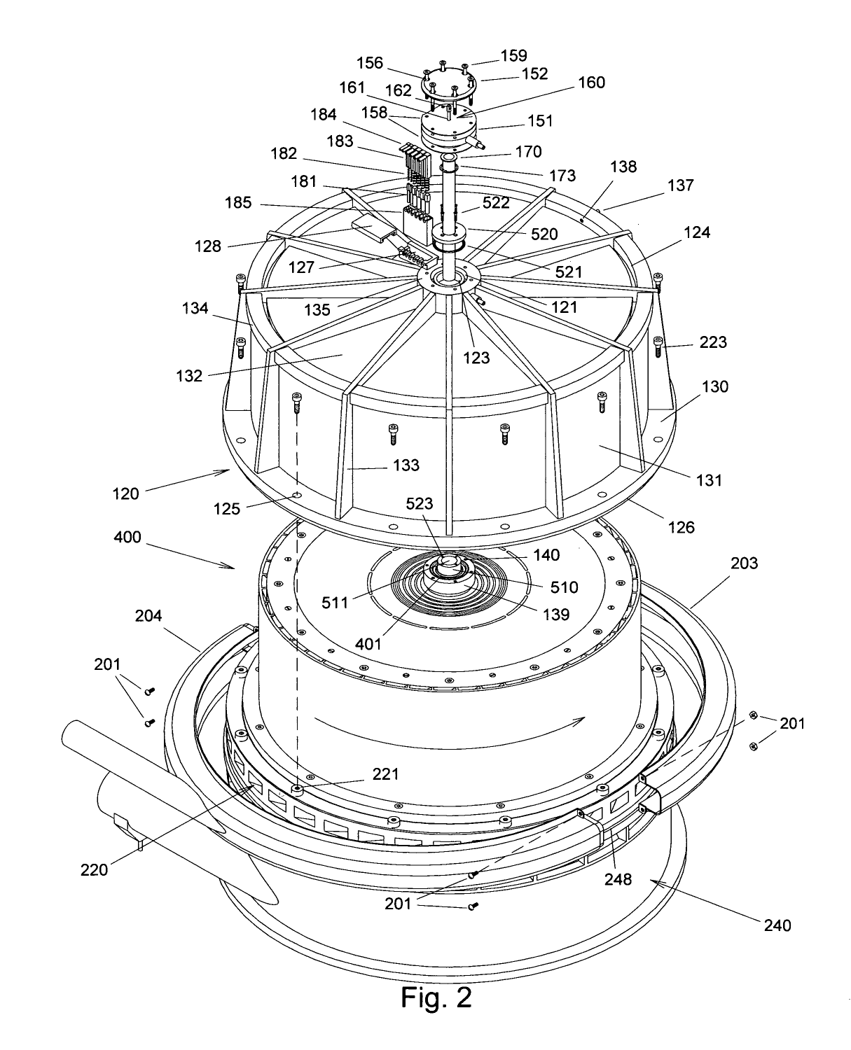

FIG. 2 illustrates the engine with the engine cowling, 120, removed. Removal of the engine cowling requires removal of the exhaust manifold sections, 203 and 204. Removal of exhaust manifold reveals exhaust stator ring, 220, attached to the engine base, 240. Exhausted steam enters the exhaust manifold through the openings of the stator ring. Threaded fasteners, 201, join the exhaust manifold sections. The exhaust manifold is vertically confined from above by an annular rim, 126, emanating from cowling base flange, 130. The exhaust manifold is confined from below by annular rim, 248, emanating from the engine base.

Removal of the engine cowling first requires removal of the fuel inlet. The fuel inlet includes fuel inlet cap, 152, and fuel inlet body, 151, with fuel float tube, 170, affixed to the base the fuel inlet body by retainer ring, 173. The float tube extends downward through axle passage, 123, of the engine cowling and into fuel inlet reservoir, 511, in the upper axle, 510. The fuel inlet body seats on a horizontal-mating surface, 135, atop the engine cowling. Gaskets, 158, prevent fuel leakage. Threaded fasteners, 159, pass through the fuel inlet cap, fuel inlet body, gaskets and engine cowling, and secure to bearing collar, 139. The bearing collar seats in a recess emanating upward from the underside surface of circular plate, 132. When installed, the heads of the threaded fasteners bear against countersunk seats, 156, and secure the fuel inlet cap, fuel inlet body, gaskets, and bearing collar to the engine cowling. Threaded fasteners, 522, secure to fastener seats, 523, and join fuel slinger, 520, to the upper axle. Stationary, fuel slinger seal, 521, seats in a groove in the wall surrounding the axle passage and forming the inner-radius wall of a fuel overflow trough and drain, 121. The fuel slinger forms a weir at the top of the axle and limits fuel, which swirls up the interior wall of the fuel inlet reservoir, from spilling over the top of the axle and into the fuel overflow trough and drain. Purged air and other gases passes through a small annular gap between the fuel slinger and float tube. The fuel slinger, fuel slinger seal, and fuel overflow trough and drain prevent fuel from passing downward through the axle passage and entering upper bearing, 401. The cages of the upper bearing abut the upper axle and bearing collar. The bearing collar presses onto the anti-friction bearing. The bearing collar is made of a machinable metal, and is held stationary by the fasteners securing the fuel inlet cap and fuel inlet body to the engine cowling.

A needle valve, 160, travels vertically in the center of the fuel inlet body and an upward emanating recess in the fuel inlet cap. The needle valve has a cylindrical tube, 161, descending from a polygonal upper body, 162. Upward travel of a fuel float in the float tube moves the needle valve into the fuel inlet cap and stops the flow of fuel into the inlet reservoir.

The engine cowling is structurally comprised of the base flange, 130, a cylindrical-shell wall, 131, and the circular plate, 132. The wall and circular plate are separated by air inlets, 124, but are rigidly joined by structural ribs, 133. The annular perimeter wall is strengthened by upper ribband, 134. Purged gas separated from liquid fuel in the liquid/gas separator reenters the engine through gas return ferrule, 137, which inserts into galley, 138, and is vented into the air inlets. The interior surface of the engine cowling conforms to the exterior shape of rotating assembly, 400, but with slightly greater radii that allow free and unimpeded rotation of the rotating assembly. Viewed from above, rotation is counterclockwise. The cowling design permits the use of a polymer such as polyphenylene sulfide, or PPS^{xxxix}. All threaded fasteners pass through the cowling and seat in parts constructed of materials well suited for machining. Threaded fasteners, 223, insert into countersunk seats, 125, in the cowling base flange. The fasteners secure to raised fastener seats, 221, on the exhaust stator ring. The bosses of the fastener seats insert into recesses emanating upward from the bottom surface of the cowling base flange. xxxix Smith, Foundations of Materials Science and Engineering, 2^{nd} Edition, p. 328

FIG. 2 reveals the armature brush assembly. Dielectric spacer insert, 185, inserts into the armature brush cavity, 127, of the engine cowling. The armature brush assembly is accessed by sliding armature brush cap, 128, radially outward. Armature brushes, 181, travel in conducting sleeves, 183. Helical springs, 182, insert into the sleeves. The springs keep the brushes fully extended. External wiring connects to wiring connectors, 184. The armature brushes experience significant wear, and the design facilitates periodic replacement.

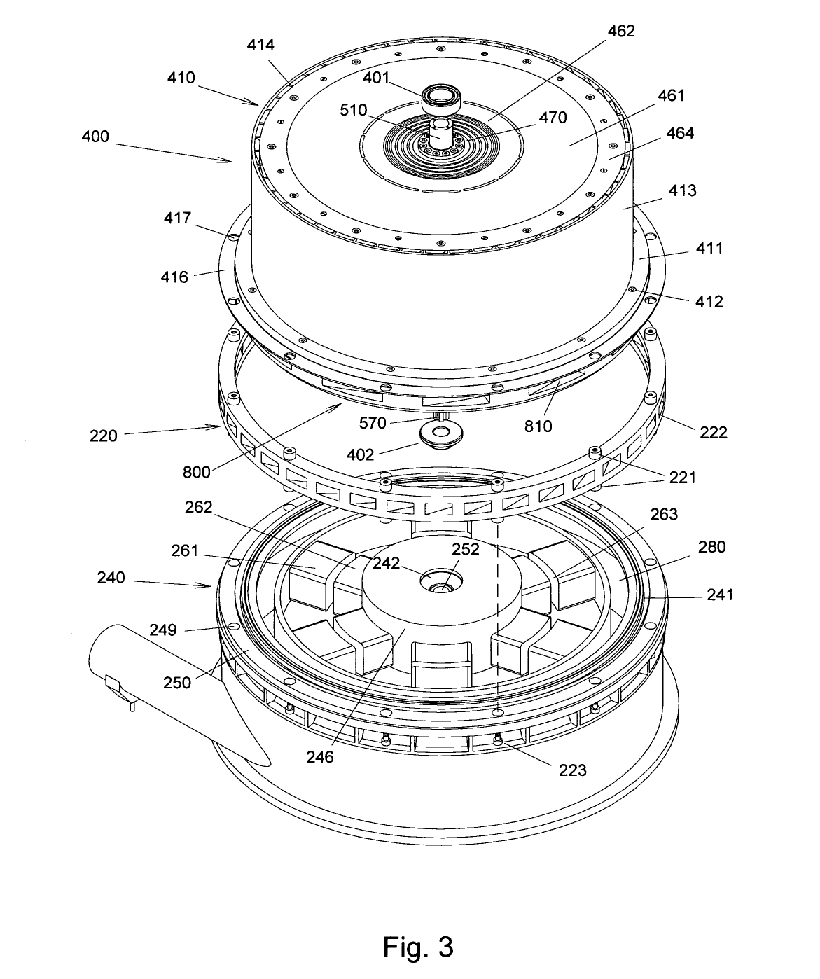

FIG. 3 illustrates removal of rotating assembly, 400, from the stationary support. Rotation is counterclockwise. Anti-friction bearing, 401, is removed from upper axle, 510, and anti-friction bearing, 402, is removed from lower axle, 570. The upper bearing is depicted as a multi-rowed ball bearing that is suitable for high lateral loads. The lower bearing is depicted as a tapered-roller bearing that supports both vertical thrust and lateral loads. Various types of bearings and bearing placement can be used in alternate embodiments.

The upper surface of the rotating assembly includes slip-ring plate, 461, slip rings, 462, inner retainer ring, 470, and outer retainer ring, 464. An armature brush aligns with each slip ring. The outer-radius wall of the rotating assembly is fan shroud, 413, of axial-flow fan, 410. Fan vanes, 414, emanate inward toward the radially inward disposed, rotating elements of the engine. The axial-flow fan has a base flange, 411, that is secured to nozzle wheel, 800, by a circular array of round-bolt-head, threaded fasteners, 412. When seated, the upper surfaces of the round bolt-heads are flush with the upper surface of the base flange, thus forming a low-aerodynamic-drag surface. Steam nozzles, 810, are arrayed around the nozzle wheel. Exhaust vapor flows outward between stator vanes, 222, of exhaust stator ring, 220. The stationary element of a knife-edge seal, 416, is held fixed by alignment holes, 417, which slide over the bosses of the raised fastener seats, 221, of the exhaust stator ring. The exhaust stator ring is secured to engine base, 240. Fastener seats, 221, emanate downward from the bottom of the exhaust stator ring, and plug into matching recesses, 249, that emanate downward from mating surface, 250, of the engine base. Threaded fasteners, 223, secure to the descending fastener seats of the stator ring. The exhaust stator ring should be made of a strong machinable metal such as aluminum or stainless steel. This arrangement allows the primary materials of the engine cowling and engine base to be a high strength polymer such as PPS.

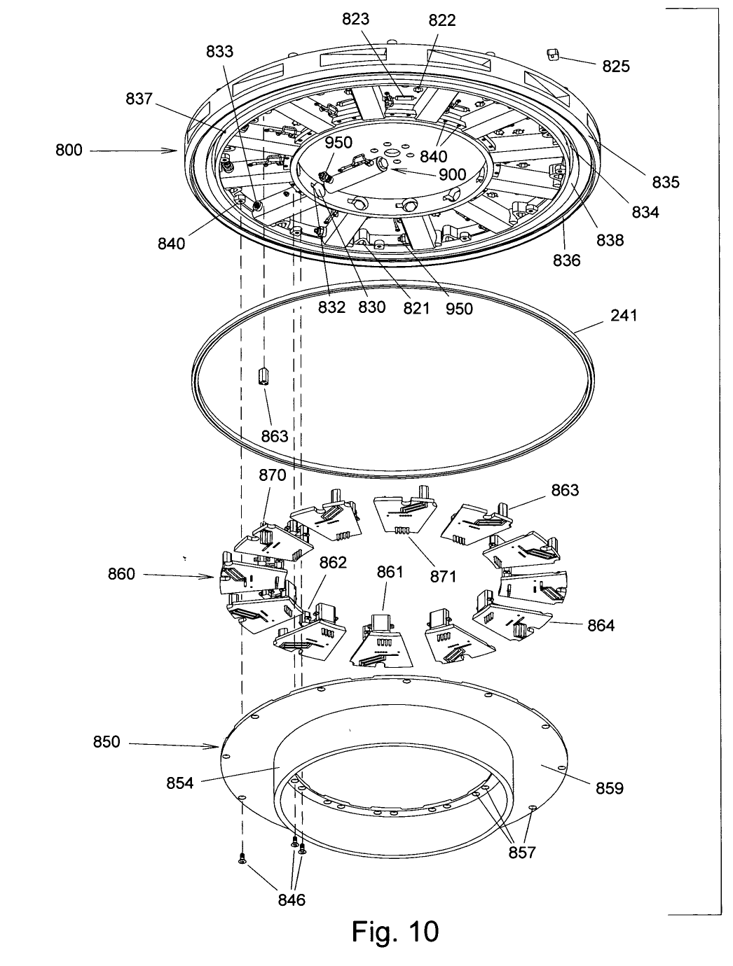

The tapered roller bearing presses into bearing seat, 242, in bearing pedestal, 246, at the center of the engine base. Lower axle shaft, 570, rotates in lower axle passage, 252, through the engine base. Byproduct reservoir, 280, is an integral part of the engine base. Byproduct is expelled from the base of the nozzle wheel into the reservoir. The annular reservoir facilitates periodic removal of accumulated fuel byproduct. This will likely be done with an auger device, which is beyond the scope of this design. Vapor-barrier-bearing, 241, sits against a vapor-barrier-bearing seat, FIG. 10, 836, at the base of the nozzle wheel. The inner-radius cage of the bearing seats on bearing seating rim, FIG. 22, 243. This embodiment contemplates an anti-friction, ball bearing with a separator for spacing rolling balls, and sealed-grease lubrication. The vapor-barrier-bearing is largely non-load-bearing; the purpose of the bearing being to keep fuel vapors that might be present in the byproduct reservoir from the environment. Induction loop channel, 263, is disposed between an outer-radius magnet, 261, and an inner-radius magnet, 262. Induction loop assembly, FIG. 10, 850, which attaches to the underside of the nozzle wheel, moves rotatably within this channel. The magnets are symbolic blocks that illustrate placement. Permanent magnets or electromagnets might be used in alternate embodiments.

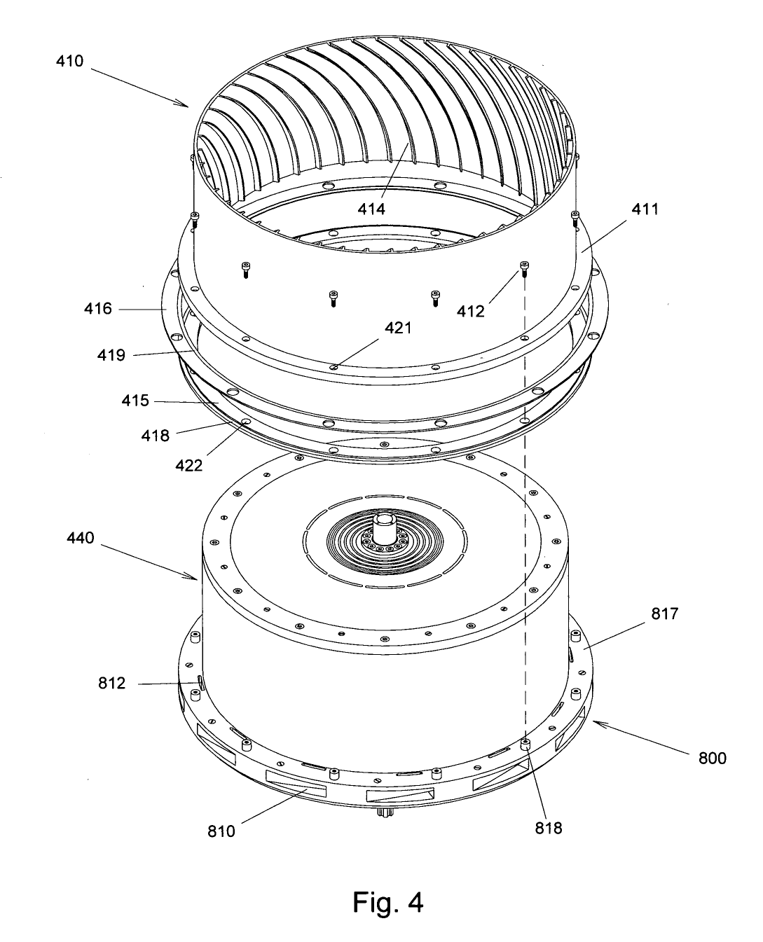

FIG. 4 illustrates the separation of axial-flow fan, 410, from the remainder of the rotating assembly. Fan vanes, 414, abut the outer-radius surface of cathode-gas plenum, 440, at their inner radii, and add structural support to the plenum wall. Threaded fasteners secure the fan to nozzle wheel, 800. Round-bolt-head, fasteners, 412, secure to raised, fastener seats, 818, which emanate from mating surface, 817, on the nozzle wheel. The round fastener heads seat in countersunk seats, 421, in base flange, 411, of the fan. When seated, the upper surfaces of the fasteners are flush with the upper surface of the flange. The bosses of the raised seats insert into recesses that emanate upward from the bottom surface of the base flange. Fan spacer, 415, is disposed between the base flange and the nozzle wheel. Alignment holes, 422, slide onto the bosses of the raised fastener seats of the nozzle wheel. The knife-edge, 419, of knife-edge seal, 416, is caged in an inset channel, 418, formed between the fan spacer and the base flange of the fan. The knife-edge seal produces no friction by direct contact, but creates a tortuous flow path that reduces axial flow in or out of the small separation between the nozzle wheel and stator ring.

Air is energized as it flows downward through the fan. The vanes become vertical at their base. Energized air exiting the fan enters inlet passages, 812, which channel the airflow into steam nozzles, 810. The fan can be made of polymers or metals. If engine cooling is necessary, the axial flow fan should be made of a heat-conducting material such as aluminum. When the fan is secured to the nozzle wheel, the combined shape of the rotating assembly is aerodynamically smooth and produces little drag during rotation except at the fan inlet.

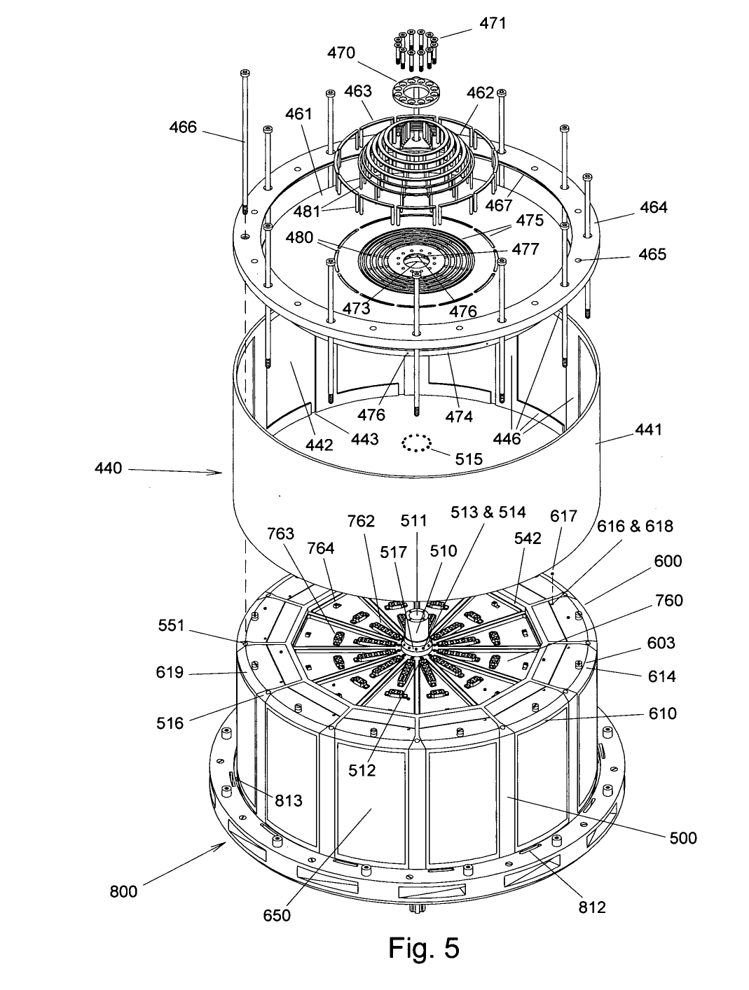

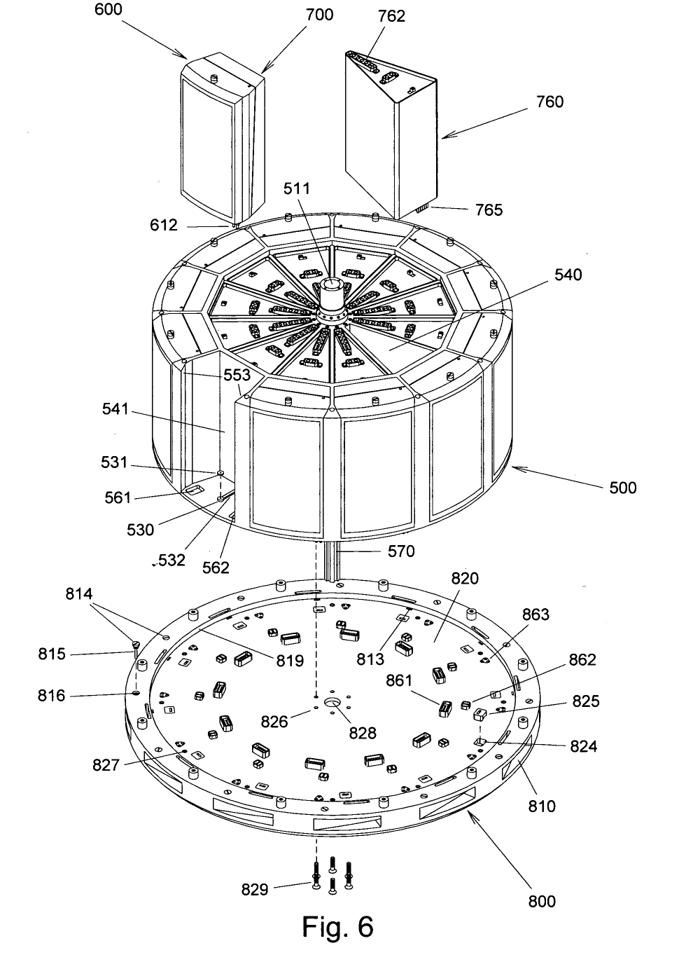

FIG. 5 illustrates removal of the slip ring assembly and cathode-gas plenum. Threaded fasteners, 471, secure to fastener seats, 512, surrounding the upper axle and join inner retainer ring, 470, to rotor frame, 500. Long threaded fasteners, 466, secure outer retainer ring, 464, to nozzle wheel, 800. The long fasteners pass through holes, 551, through the rotor frame before securing to fastener seats, FIG. 6, 827, in the nozzle wheel. The outer retainer ring has a conical surface that conforms to the conical-chamfered surfaces, 619, of ion pumps, 600, and, 516, of the rotor frame. The conical surfaces add centripetal support at the tops of the ion pumps. Upper axle, 510, passes through axle passage, 473, of the slip ring plate, 161. A lower, descending bottom surface of the slip-ring plate conforms to the polygonal recess, 542, of the rotor frame, in which it rests. The inner and outer retainer rings secure the slip-ring plate to the rotor frame.

Slip rings, 462, insert into recessed tracks, 475. Integral electrical plug pins, 481, descend through passages, 480, through the slip-ring plate. The slip rings plug into receptacles, 762, of electronic control modules, 760. Control module conductors, 463, interconnect the control modules. The conductors seat in recessed tracks, 475. Electrical plug pins, 481, of the control-module conductors, pass through the slip-ring plate and plug into electrical receptacles, 763. Working in conjunction with switches, 764, the interconnection of the control modules allows the operating mode of each ion pump to be changed. Each ion pump can be configured as a series terminus anode, an intermediate-series ion pump, or a series terminus cathode. Diodes regulate the direction of current. An alternate embodiment might substitute electrically actuated switches for the manual switches, thereby allowing mode switching through slip-rings from series to parallel while the engine is operating. System ground and electric power are transmitted through the slip rings. Signals such as exhaust valve timing, oscillator circuit controls or power, and ion pump discharge might be transmitted to the electronic control modules through slip rings.

Air purge galleys, 476, extend radially inward from outer conical sealing surface, 474, to inner conical seating surface, 477, of the slip-ring plate. The galleys pass between the electrical plug and fastener passages through the slip ring plate. The inner-radius terminus of each galley aligns with a connecting air purge galley, 513, extending through the upper axle, and into fuel inlet reservoir, 511. Short, vertical galleys intersect the radial galleys. When the slip-ring plate is seated, the short, vertical galleys align with galleys and recessed o-ring seats, 616 and 618, in the dielectric frame, FIG. 9, 610, of the ion pumps. Small o-rings, FIG. 5, 617, seat in the dielectric frame. Additional o-rings, 515, seat in recessed seats, 514, in conical seating surface, 517, of the rotor frame. When the slip-ring plate is secured in place, all o-rings are compressed and all joints of the air purge galley are sealed. The outer retainer ring has a conical sealing surface, 467, that bears against the outer conical sealing surface of the slip ring plate. The outer-radius ends of the radial galleys are plugged, and the union is treated with a sealant, which is impervious to fuel.

Fill-necks, 614, and caps, 603, of the ion pumps insert into passages, 465, through the outer retainer ring. When installed, the upper surfaces of the caps are flush with the upper surface of the outer retainer ring. When the slip rings, control-module conductors, inner and outer retainer rings, and all fasteners are in place and secured, the exposed aggregate surfaces are flush and produce little aerodynamic drag.

FIG. 5 illustrates the separation of cathode-gas plenum, 440. The cathode-gas plenum has a circular array of radially shallow plenum chambers, 442. Each shallow cavity is bordered by plenum surrounds, 446, and plenum wall, 441. The plenum surrounds abut rotor frame, 500, dielectric frames, 610, and, in part, the ion pump cathodes, 650. Gas evolving from the ion-pump cathode enters the plenum chamber and passes through gas outlet, 443, at the base of the plenum chamber. The plenum gas outlets align with hydrogen gas inlets, 813, in the nozzle wheel. The hydrogen gas inlets merge into inlet passages, 812. Low pressure caused by airflow across the gas inlets produces a draw on the plenum chambers. Outer retainer ring, 464, abuts the cathode-gas plenum at the top, and secures it to the rotor frame. The plenum surrounds overlap narrow borders around the perimeters of the cathodes. Because of the contact with the cathodes, the plenums should be made of a polymer having high dielectric strength that prevents movement of charge from cathode to cathode.

If engine cooling proves to be necessary, the plenum would be made of different materials. The plenum wall would be of a heat conducting metal, while the plenum surrounds would be of a dielectric material. Airflow through the axial-flow fan would cool the adjoining metal surface of the plenum wall. Thermal energy added to the airflow might be recovered as thrust. Alternate embodiments might have the axial-flow fan and cathode-gas plenum produced as a single part.

FIG. 6 illustrates the removal of ion pump assembly, 600, and ultrasound transducer assembly, 700. Together, the assemblies are an activation cell, and insert into slot, 541, in the rotor frame, 500. Centripetal compression flanges, 553, prevent radial movement of the ion pumps. Ion pumps plug into byproduct discharge passages, 561, for discharge of hydrogen-depleted carbon byproducts, and electrical plug passage, 562, for connection to electronic control modules, 760. Byproduct discharge passages through the rotor frame align with byproduct discharge passages, 824, in the nozzle wheel. Electrical plugs, 612, plug into electrical receptacles, 863, in the nozzle wheel. Each ultrasound transducer assembly has an electrical plug that inserts into receptacle, 862, that is attached to the nozzle wheel. The union supplies current from the electronic control modules to the ultrasound transducers. The control modules seat in bays, 540, of the rotor frame. Each control module has an electrical plug, 765, which seats in electrical plug passage, FIG. 20, 564, in the rotor frame and plugs into receptacle, FIG. 6, 861, attached to the nozzle wheel.

Fuel flows radially from fuel inlet reservoir, 511, through a circular array of fuel inlet galleys, 532 on rotor-frame base plate 560. Gaskets, 531, seat in recess, FIG. 8, 675, of the ion pumps and seal fuel galley outlets, FIG. 6, 530.

FIG. 6 illustrates the separation of the rotor frame from the nozzle wheel. Threaded fasteners, 829, pass upward through countersunk fastener holes, 826, surrounding lower axle passage, 828, at the center of the nozzle wheel. Lower axle, 570, inserts through the passage. The fasteners secure to fastener seats, FIG. 20, 571, in the rotor frame. When in place, the base plate of the rotor frame abuts recessed surface, 820, of the nozzle wheel. Grommets, 825, seat in the nozzle wheel and seal byproduct discharge passages, 824. Separation of the rotor frame reveals vertical, seating surface, 819, which confines the lower edge of the cathode-gas-plenum wall. Hydrogen gas inlets, 813, merge into steam nozzles, 810. Catalytic ignition plugs, 814, screw into threaded seats, 816. Catalytic stem, 815, extends through the steam nozzle passage. Air and hydrogen gas mix as they enter the tangential nozzles. The gases flow around the catalyzing ignition stems near the nozzle throats. Hydrogen and oxygen react explosively when exposed to microscopic traces of platinum that are on the surface of the catalytic stem.

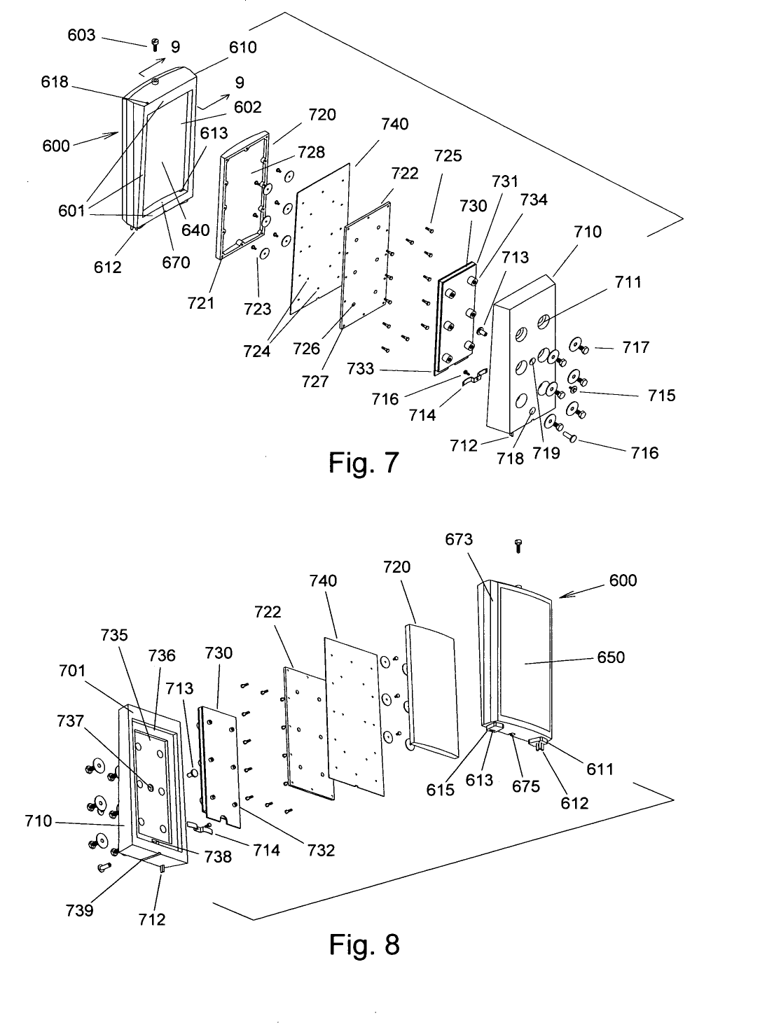

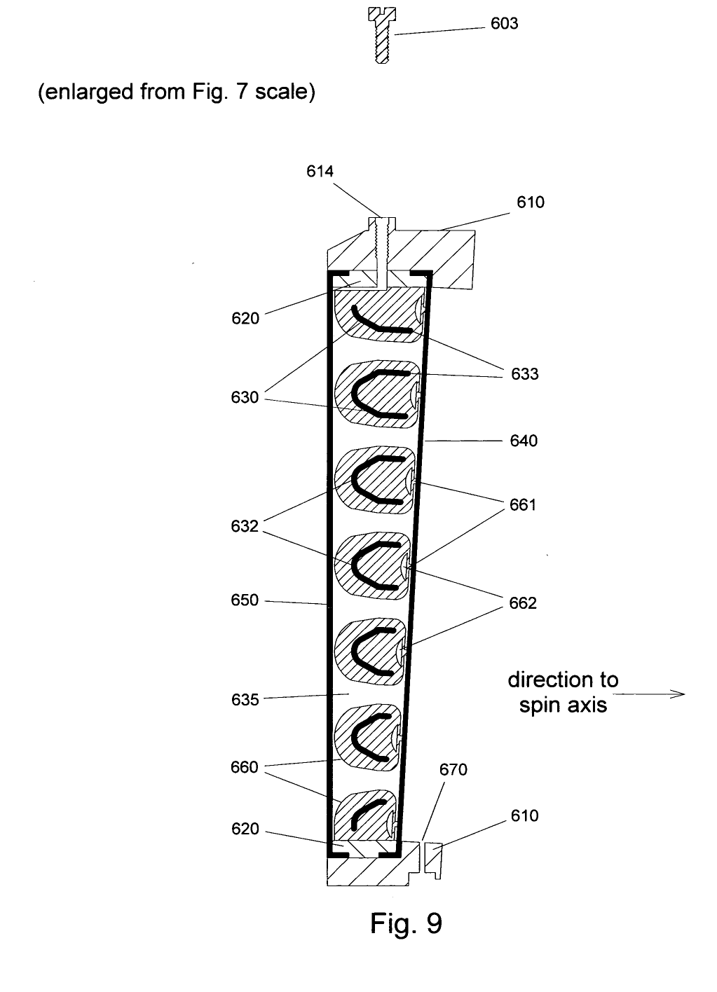

FIG. 7 discloses the elements of the ultrasound transducer assembly. Transducer resonator plate, 730, is anchored to transducer housing, 710. The transducer plate mounts at an angle from the vertical axis. The outer-radius surface of the plate inclines inward toward the axis-of-rotation with increasing elevation. The incline of the transducer is parallel to the incline of ion-pump anode, 640. Threaded fasteners, 717, insert into countersunk seats, 711, and secure to transducer mounting plate, 731, which is permanently affixed to the inner-radius surface of the transducer. The fasteners secure to fastener seats, 734, on the transducer-mounting plate. A second transducer mounting plate, 733, is permanently affixed to the outer-radius surface of the transducer. Electrical contacts bear against both mounting plates. The inner-radius surface of the transducer is held fixed in place in the transducer housing, while the outer-radius surface of the transducer moves. Current passes through fixed electrical contact, 713, to the inner-radius mounting plate, and through flexible electrical contact, 714, to the outer-radius mounting plate. The flexible contact maintains electrical contact with the outer-radius mounting plate as it vibrates. Both electrical contacts are secured to the terminal ends of electrically isolated conductors that are integrally molded into the transducer housing. The embedded conductors extend from two-pin electrical plug, 712, to recesses, where the conductors terminate as partially exposed seats. The fixed electrical contact is secured by threaded fastener, 715, through recessed terminal, 719. Threaded fastener, 716, secures the flexible electrical contact to recessed terminal, 718.

Vibrator plate, 720, is indirectly secured to the outer-radius transducer mounting plate. Threaded fasteners pass through washers, 723, and holes, 724, in flexible fuel diaphragm, 740, and holes, 726, through vibrator backing plate, 722, before securing to raised fastener seats, FIG. 8, 732, on the outer-radius, transducer mounting plate. The fasteners secure the fuel diaphragm to the vibrator backing plate, and the vibrator backing plate to the transducer. A second set of threaded fasteners, FIG. 7, 725, passes through holes, 727, and secure the vibrator backing plate to the vibrator plate. An array of fastener seats, 721, border vibrator plate recess, 728.

The flexible fuel diaphragm is held between bonding surface, 601, of the dielectric frame, 610, of the ion pump, 600, and reflected and opposing surface, FIG. 8, 701, of the transducer housing. The activation cell assemblies insert into slots in the rotor frame. Centripetal compression flanges hold the activation cells in place in the rotor frame. The outer retainer ring exerts downward force on the dielectric frame of the ion pumps. The force compresses the flexible fuel diaphragm between the opposing bonding surfaces.

When joined, the vibrator plate nests in fuel vessel recess, FIG. 7, 602, that is bordered by the ion-pump anode and dielectric frame. The vibrator plate is separated from the anode by a distance of about 0.5 millimeters. Fuel fills this space. Fuel enters through fuel inlet galley, 670, through the lower rail of the dielectric frame. Hydrogen-depleted fuel byproduct exits the fuel vessel through passage, 613, disposed at the lower trailing corner of the ion-pump anode. When rotated, the incline of the ion-pump anode produces centrifugal acceleration that points downward and radially outward along the anode surface. The acceleration prevents heavier, hydrogen-depleted carbon byproduct from accumulating on the ion-pump anode surface. The angle of incline is 3 degrees, but might be varied in alternate embodiments. The transducer generates pressure waves having the intensity to dehydrogenate hydrocarbon fuel accelerated against the catalyzing surface of the ion pump anode. Rotation propels the byproduct toward the discharge passage. Unwanted air and gaseous fuel fragments vent through an air purge galley that extends through the upper rail of the dielectric frame. The vertical galley terminates in o-ring recess, 618. The ion pump is filled by removing threaded cap, 603.

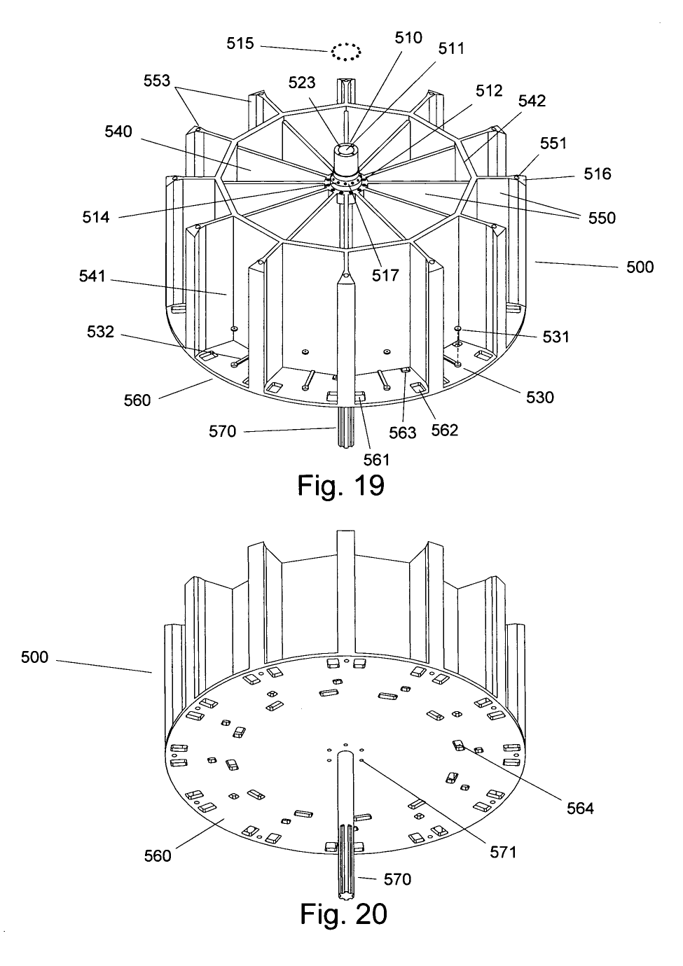

FIG. 8 is the opposing, exploded view of the ultrasound transducer assembly. The isometric view is from below the radial plane. Transducer, 730, seats in recess, 735. Vibrator backing plate, 722, moves in recess, 736. Electrical plug, 712, extends from the base of the transducer housing, 710. Flexible fuel diaphragm, 740, is compressed against diaphragm mating surface, 701. Fixed electrical contact, 713, seats in recess, 737, and flexible electrical contact, 714, seats in recess, 738. Fuel galley recess, 739, conforms to the exterior shape of the fuel inlet galley, FIG. 19, 532. The outer-radius surface of the vibrator plate, FIG. 8, 720, is curved and parallel to the ion-pump anode. Three electrical connections are made through pins, 612. One pin has electrical continuity with the anode, the second pin has continuity with the cathode, and the third pin has continuity with the bus bar joining the false anodes. Frame extensions, 611 and 615, plug into openings through the base plate of the rotor frame. Byproduct is discharged through passage 613. Frame surface, 673, abuts the compression flanges of the rotor frame. Curvature of the cathode conforms to the radius from the spin axis.

FIG. 7 and 8, 730, is a symbolic representation of a transducer plate. Compressive vibrations of transducer plates occurs at higher frequencies. The dimensions of the transducer plate might be derived from known operating parameters^{xl}. The oscillator circuit for the ultrasound transducer operates at 4.553 MHz, and each of twelve activation cells dissipates about 1,542.23 watts, and requires a plate compression of 14.84 nanometers. A 10,000 volts per meter electric field produces about a 2×10⁻⁸ strain in quartz^{xli}. Compressive displacement of 14.84 nanometers requires a 7,420-volt potential. The electromechanical coupling of quartz is about 10%, so little rebound energy is stored in the crystal. For the illustrated transducer, where the primary vibration mode is along the same transducer axis as the electric field, the oscillator is a damped, series LC circuit. The ratio of the transducer-plate surface area to thickness is proportional to its dielectric capacitance. In this simplest circuit, a transducer-plate thickness of about 7 mm would yield an ultrasonic intensity of about 259 W cm⁻². The theoretical maximum ultrasonic intensity that can be obtained in water using quartz is about 2,000 W cm^{-2 xlii}. The intensity delivered to the fuel at the anode surface is about 7 W cm⁻². Resistance due to damping losses in piezoelectric crystals such as quartz is in the range of 10² to 10⁴ ohms^{xliii}. Heat gain might be used to preheat the fuel inflow. For the crystal thickness, mechanical resonance is much lower than the driving frequency. When the driving frequency and mechanical resonance coincide, maximum wave amplitude occurs. Alternate embodiments might use assemblies of multiple piezoelectric crystals or different crystal cuts, vibration modes, or electric-field axes, and/or different materials or combinations of materials including barium titanate, PZT ferroelectric ceramics and magnetostrictive materials that increase mechanical resonance, produce greater wave amplitude, or both. xl McGraw-Hill Encyclopedia of Physics, 2^{nd} Edition, p. 1034, Network elementsxli McGraw-Hill Encyclopedia of Physics, 2^{nd} Edition, p. 1034xlii McGraw-Hill Encyclopedia of Physics, 2^{nd} Edition, p. 1037xliii McGraw-Hill Encyclopedia of Physics, 2^{nd} Edition, p. 1036

FIG. 9 is an enlarged cross-section of the ion pump assembly. Water reservoir, 635, is bounded by at the inner radius by ion-pump anode, 640, and at the outer radius by the cathode, 650. An inner dielectric frame, 620, bounds the water reservoir at the top and bottom, and is disposed within the outer dielectric frame, 610. Fill neck, 614, passes through both the inner and outer dielectric frames, and is sealed with cap, 603. Fuel inlet galley, 670, passes through the lower rail of the dielectric frame.

False anodes, 630, are isolated from the water by insulation, 660. The thickness of the insulation thins relative to the surface of each false anode, with decreasing distance from the axis-of-rotation, which lies to the right. The inner-radius insulation surface is parallel to the anode, except where the insulation forms a narrow bridge, 661, across the gap between the insulation and the anode surfaces. By marginally increasing the overall thickness of the insulation, the gap can be reduced, thereby putting mobile anions closer to the anode surface. The narrow bridge transmits vibration of the anode into the water reservoir, and stops the upward migration of hydrogen molecules that enter the water. A gas-filled cavity, 662, in the insulation and adjacent to the insulation bridge increases deflection along the insulation surface. Each water reservoir has a volume of about 0.3 liters. Twelve ion pumps have a combined water volume of about 3.5 liters.

Attraction between the false anode and anions in solution, and the changing thickness of the surrounding insulation creates a force parallel to the exterior surface of the insulation and in the direction toward the anode. The force depends upon the charge applied to the false anodes and the angle between the insulation surface and the false anode where the insulation thickness changes. The insulation might be layered. A high voltage might be applied to the false anodes. The innermost insulation layer abutting the false anodes might be a high-strength insulator such as poly-p-xylylene, polyetherimide, or an aromatic polymer film. The dielectric strengths range from 338 to 590 kV per millimeteriv. A second material having a low dielectric constant might be layered over the high-resistance film. Polytetrafluoroethylene has a dielectric constant of 2.1^{xlv}. Depending on the materials used, insulation thicknesses used on the false anodes and related circuits are adjusted to protect against electrical breakdown at the applied voltage. xliv CRC Handbook of Chemistry and Physics, 82^{nd} Edition, p. 15-33xlv CRC Handbook of Chemistry and Physics, 82^{nd} Edition, p. 13-15

False anode vertices, 632, are nearest the cathode. The termini of the legs, 633, are nearest the anode. Straight sections of the false anodes at their termini are perpendicular to the anode surface. About half of the false anode surface lies on each side of the midline between the ion pump anode and cathode. The cross-section reveals that the curved surfaces around the vertices of the false anodes and nearest the cathode, face outward, away from the spin axis. The straight surfaces of the legs face the legs of adjacent false anodes, with adjacent pairs converging in the direction toward the anode or being parallel. Mutual repulsion between unshielded like charges of adjacent false anodes, increases the positive surface-charge-density near the vertices, which attracts electrons to the cathode and generates an overpotential at the cathode surface. The uppermost and lowermost false anodes are the lower and upper halves, respectively, of an otherwise full false anode. Spacing between opposing surfaces of the legs of a single false anode and spacing between opposing surfaces of adjacent false anodes are about equal at the widest point. The convergent angle and distance between the legs of adjacent false anodes, and the number of false anodes and their shapes might differ in alternate embodiments that optimize performance. Bus bars are affixed to the arc ends of the vertical array of false anodes.

The ion-pump anode and cathode membranes will likely be laminar. Niobium will likely be the principal material of the membrane. To stop contamination of the substrate metal, which is permeable to other elements, approximately 1 to 2 micron-thick layers of palladium shield UHV outgassed niobium^{xlxi}. Palladium is selectively permeable to hydrogen gas^{xlvii}. Palladium can absorb over 900 times its own volume of hydrogen at room temperature^{xlviii}. In the temperature range from 25 to 100° C., the resistivity of Pd is nearly that of Pt^{xlix}. Palladium is malleable and ductile and can be hammered into foils less than 1 μm of thickness. Hammering increases the hardness and strength of the precious metal. Other membrane alternatives are mentioned in the literature. Niobium is alloyed with titanium and palladium. Palladium is also alloyed with fcc silver^{li}. Alloys of titanium and iron, and nickel and magnesium soak up hydrogen^{lii}. The presented embodiment is a Pd|Nb|Pd laminate. Palladium provides a catalytic surface and atomic filtering of hydrogen, while cheaper niobium adds structure. xlvi J. Völkl and G. Alefeld, Topics in Applied Physics, Hydrogen in Metals I, p. 329xlvii Gilbert W. Castellan, Physical Chemistry, 3^{rd} Edition, p. 21xlviii CRC Handbook of Chemistry and Physics, 82^{nd} Edition, p. 4-22xlix CRC Handbook of Chemistry and Physics, 82^{nd} Edition, p. 12-46l John Emsley, Nature's building Blocks, p. 309li E. Wicke and H. Brodowsky, Topics in Applied Physics, Hydrogen in Metals II, p. 145, table 3.4lii John Emsley, Nature's building Blocks, p. 187

FIG. 10 illustrates separation of induction loop assembly, 850, from nozzle wheel, 800. The induction loop assembly attaches to the bottom of the nozzle wheel. Threaded fasteners, 846, pass through countersunk seats, 857, and secure to fastener seats, 840.

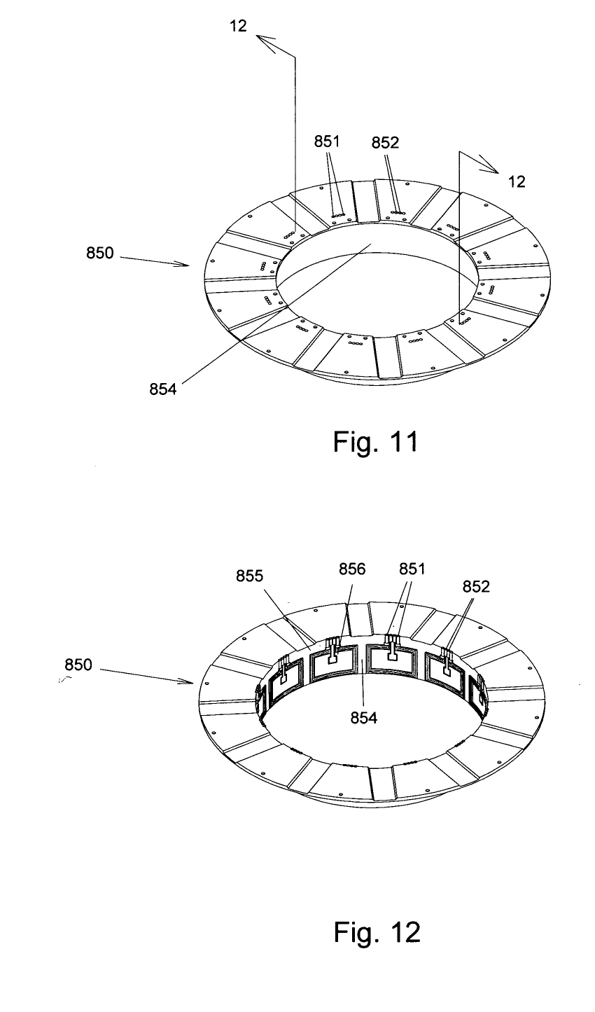

A circular array of junction boards, 860, plug into the induction loop assembly and rest on circular plate, 859. Four descending electrical plug pins, 871, insert into electrical receptacles, FIG. 11, 851, that connect to outer induction loops, and electrical receptacles, 852, that connect to an inner induction loop. The induction loops are embedded in descending induction loop housing, FIG. 10, 854. The junction boards plug into electrical receptacles, 863, that insert into electrical receptacle seats, 821, in the nozzle wheel. Three pins, 870, extend upward from each junction board, 864, and insert into the lower end of the receptacle. The three-pin plug at the base of the ion pumps plugs into the opposite end of receptacle 863. Electrical receptacles, 861, insert into receptacle seats, 823, in the nozzle wheel. Two-pin receptacles, 862, inserts into seats, 822.

Exhaust valve assembly, 900, seats in exhaust valve cavity, 830, in the nozzle wheel. When actuated, the exhaust valves expel fuel byproduct through byproduct ejection ports, 837. Each exhaust valve aligns with an ejection port. Byproduct is ejected into annular recess, 834, where the byproduct is deflected downward after colliding with surface, 838, at the outer radius of the annular recess. Exhaust valve wiring passes through keyway, 832. A ground wire connects to threaded terminal lug and nut, 831. Resistance probes, 950, thread into threaded seats, 833, and insert into the exhaust valve assemblies. Condensation is expelled by condensation-slinger surface, 835. Vapor-barrier bearing, 241, abuts bearing seat, 836. Grommets, 825, seat in the nozzle wheel and seal the entrance into the cylindrical exhaust valve assemblies.

When the junction boards and induction loop housing are secured to the nozzle wheel, the aggregate exterior surface is aerodynamically smooth and produces little drag. Wiring and receptacles must withstand the forces generated by high-speed rotation and the high voltage applied to the false anodes of the ion pumps. The junction boards in the presented embodiment illustrate wiring connections: A production design will likely be fully encased modules.

FIG. 11 and FIG. 12 are isolated views of the induction loop housing assembly, 850, and the embedded, outer and inner induction loops. FIG. 12 is a cut view, outward, through electrical receptacles, 851 and 852. The cut reveals outer induction loops, 855, and inner induction loops, 856. Annular, descending induction loop housing, 854, maintains the structural and electrical integrity of the embedded loops. The housing must not interfere with the magnetic flux through which the induction loops move, rotatably. A high tensile strength, high-temperature and high-dielectric-strength polymer might be used.

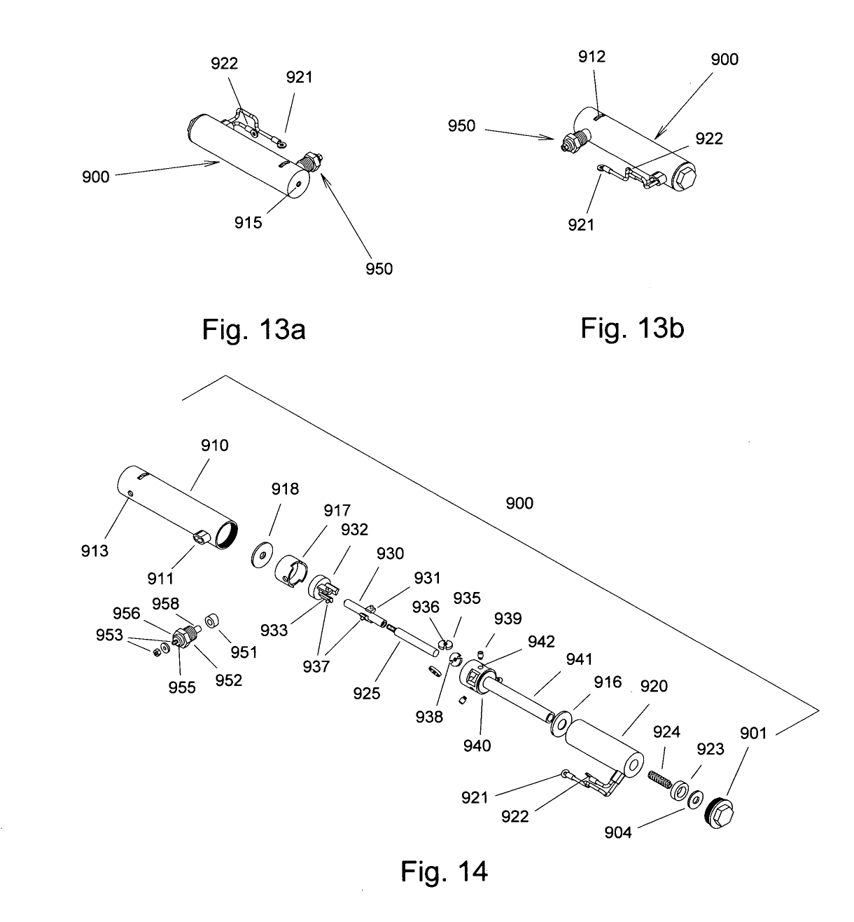

FIG. 13a and FIG. 13b are opposite end, isometric views of the solenoid-actuated, exhaust valve assembly, 900. Ejection port, 915, is at the outer-radius end of the exhaust valve. Resistance probe, 950, inserts into the exhaust valve. Solenoid ground wire and terminal washer, 922, and solenoid power wire and terminal washer, 921, connect to the solenoid coil. Byproduct enters the exhaust valve through inlet, 912.

FIG. 14 shows the components of the exhaust valve assembly, 900. End cap, 901, threads into valve housing, 910. Resistance probe extension, 958, plugs into the valve housing through entrance, 913, and into byproduct centrifuge sump, 917. Flexible grommet, 951, inserts into probe seat, FIG. 10, 833, and abuts the exhaust valve housing. A polygonal shaped wrenching nut, FIG. 14, 956, on resistance probe body, 952, facilitates installation and removal. An axially disposed conductor through each resistance probe extends from the exhaust-valve end of the probe to a threaded terminal lug and nut, 953, disposed at the opposite end. Insulation, 955, electrically isolates the conductor from the threaded body and probe extension. During operation, an electrical current is applied through the axial conductor of the probe. Current will flow across the insulation separating the conductor from the surrounding metal body of the probe as carbon from the fuel fills the sump. Current leakage initiates operation of the exhaust valves.

The interior of the sump, narrows with increasing radius from the axis-of-rotation of the engine. The narrowing sump chamber aids ejection of byproduct when valve port, FIG. 13a, 915, opens. Centrifuged byproduct is steered toward the outlet at the axial center of the sump. The sump should be lined with a material such as PTFE to which the fuel byproduct does not stick. The valve port is regulated by valve stem, FIG. 14, 930, which seats against valve seat, 918.

The valve stem connects to solenoid plunger, 925, and travels in an axial passage through counterweight, 932. Both the valve stem and counterweight have pivot pin seats, 931 and 933, respectively. Hardened pivot pins, 937, are pressed into the circular recesses of the pivot pin seats. The outer facing surfaces of both the pivot pin seats of the valve stem and the counterweight are flush when the valve stem slides into the central passage of the counterweight. The flush-aligning surfaces form a resting surface for notch gears, 935. Gear notches, 938, fit over the pivot pins pressed into the valve stem and counterweight. The assemblage slides into a gear housing, 940. Cylindrical bearings, 939, insert into bearing journals, 942, in the gear housing, and secure to seats, 936, at the centers of the notch gears. Plunger tube, 941, inserts into-solenoid, 920. A compressible seal, 916, prevents fuel or fuel byproduct from contacting the solenoid. An alignment tab at the base of the gear housing inserts into a matching recess in the sump liner. The assemblage slides into the valve housing.

Plunger return spring, 924, inserts into the plunger tube and bears against the end of the plunger. Flexible fuel seal, 904, prevents fuel or fuel byproduct from contacting the solenoid. Solenoid power wire and terminal washer, 921 and ground wire and terminal washer, 922, pass through wiring entrance, 911. Spacer, 923, is disposed between the solenoid and end cap. When installed, the exhaust valve assembly and resistance probe are sealed against leakage.

During operation, the solenoid plunger is pulled radially inward by the solenoid coil. As the plunger and valve stem move inward, the notch gears rotate and the pivot pins move within the notches. The valve stem lifts from the valve seat and the valve port is opened. Rotation of the notch gears moves the counterweight outward. The counterweight pushes into the byproduct sump, and ejects fuel byproduct while closing the sump entrance. When current is removed, the return spring pushes the solenoid plunger outward. Rotation of the notch gears pulls the counterweight inward into the gear housing and the sump entrance is opened.

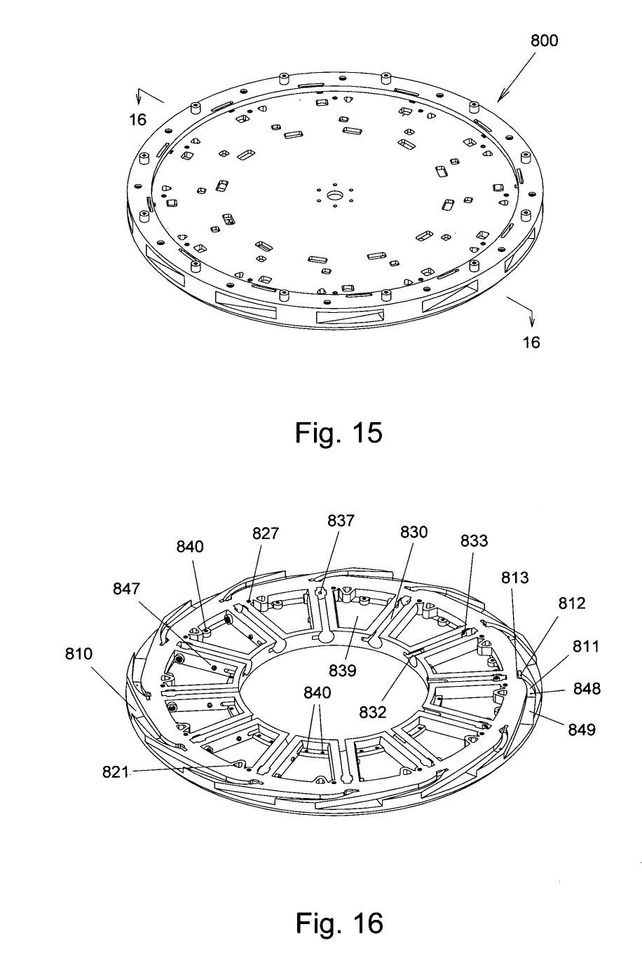

FIG. 15 and Fig.16 illustrate the interior of nozzle wheel, 800. FIG. 15 is an isometric view of the nozzle wheel, and FIG. 16 is a section view. The section cut is through hydrogen gas inlets, 813, where the inlets merge into air inlet passages, 812. The air inlet passages lead into nozzle inlet chamber, 811, where fluid flow becomes anti-parallel to the engine rotation. Catalytic stem, FIG. 6, 815, extends through steam nozzle, FIG. 16, 810, and seats in passage, 848. Gas in contact with the catalytic stem, reacts explosively as it enters divergent nozzle passage, 849. The nozzle inlet chambers might require valves, typical of pulsejets to prevent backfiring into the hydrogen and air inlet passages. An alternate embodiment might employ a flow splitter that yields a convergent passage into the inlet chamber. The narrowing would raise the velocity of gas flowing through the nozzle inlet as the flow approaches the catalytic stem.

Exhaust port, 837, is at the outer-radius end of exhaust valve cavity, 830. Exhaust-valve keyway, 832, is at the inner-radius end of the exhaust valve cavity. Resistance probe, FIG. 10, 950, inserts through threaded seat, FIG. 16, 833. Threaded fasteners secure to fastener seats, 840. Ground lug, FIG. 10, 831, presses into terminal lug seat, FIG. 16, 847. Long threaded fastener, FIG. 5, 466, secures to fastener seat, FIG. 16, 827. Electrical receptacle, FIG. 10, 863, inserts into electrical receptacle seat, FIG. 16, 821. Junction boards seat in cavities, 839.

Design of the steam nozzle passage is established by the flow of a differential element of gas as it travels through the nozzle. The vector representing the fluid flow is along a chord of a circle defined by the radius of the nozzle wheel. The chord is at the thrust radius of the nozzle wheel. As the differential element travels along the chord at supersonic speed, the gas expands to the diverging nozzle walls according to the Mach-speed area-ratio boundaries surrounding the chord. While the differential element of gas travels in a straight line, the nozzle wheel rotates.

Flow of the differential element of gas is linear and accelerates toward the nozzle exit. Rotation of the nozzle wheel is nonlinear and constant. Time is common to both forms of motion. As the idealized flow of a differential element of gas passes a point along the chord, the area-ratio boundaries for that point, and the turning nozzle walls coincide. As a first estimate, curvature of the nozzle is found by plotting the locus of instantaneous area-ratio boundaries of the linear flow in the plane of the rotating nozzle wheel as the differential element of gas travels along the chord to the outer radius of the nozzle wheel. The plots define nozzle walls having curvature over the length of the divergence from inlet to exhaust. Changes to the angular speed of the engine produce different nozzle designs. Nozzle passages, 810, are symbolic. They illustrate the theoretical, divergent area change and nozzle curvature. They do not reflect a flow-tested design. Ultimately, the nozzle passage design depends on available energy. Chemical potential in the nozzle wheel depends upon the rate hydrogen permeates through the ion-pump cathode. That depends upon the dehydrogenation of the fuel at the ion-pump anode. At 100% dehydrogenation of the fuel, each of the twelve nozzles has a throughput potential of about 3.56 horsepower.

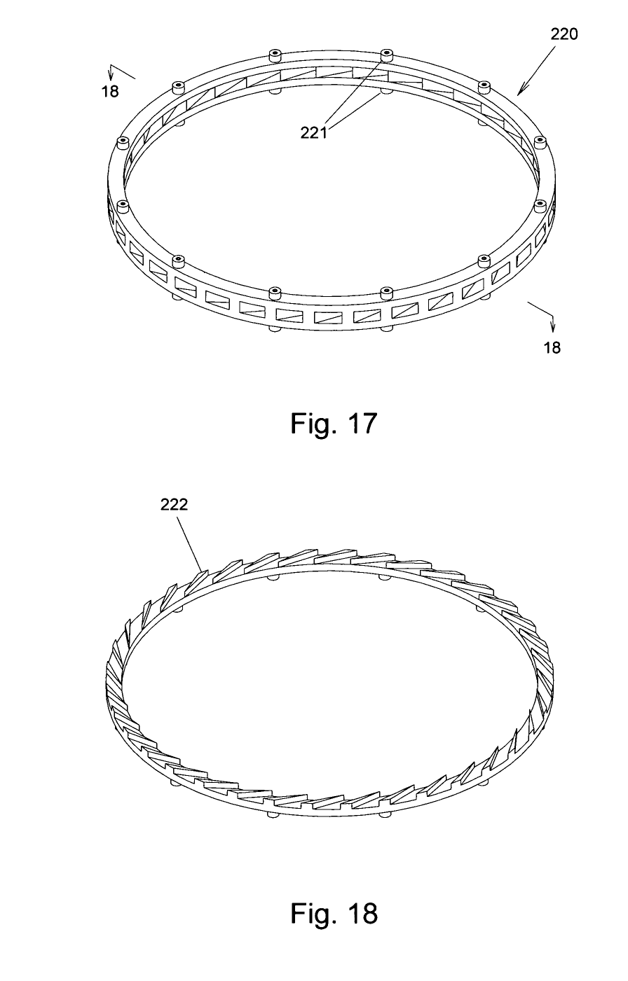

FIG. 17 and FIG. 18 illustrate exhaust stator ring, 220. FIG. 17 is an isometric view of the exhaust stator ring, and FIG. 18 is a section view. The section cut is through the vertical midline of stator vane, 222. The stator vanes are angled with respect to the radial direction from the axis-of-rotation. The angle conforms to the gas flow through the divergent passages of the nozzle wheel. Raised fastener seats, 221, are for attachment of the engine cowling and engine base.

FIG. 19 and FIG. 20 are isometric views that isolate the rotor frame, 500. FIG. 19 is from above the radial plane and FIG. 20 is from below the radial plane. Electrical plug, FIG. 8, 712, of the ultrasound transducer, inserts into electrical receptacle, FIG. 6, 862, that extends upward into electrical plug passage, FIG. 19, 563. Electrical receptacle, FIG. 6, 861, extends into electrical connector passages, FIG. 20, 564, for connection to electronic control module, FIG. 6, 760. Radial structural walls, 550, divide the rotor frame into multiple compartments. Fastener seats FIG. 20, 571, surround lower axle, 570. All other referenced elements were described in other drawings, but are repeated for clarity.

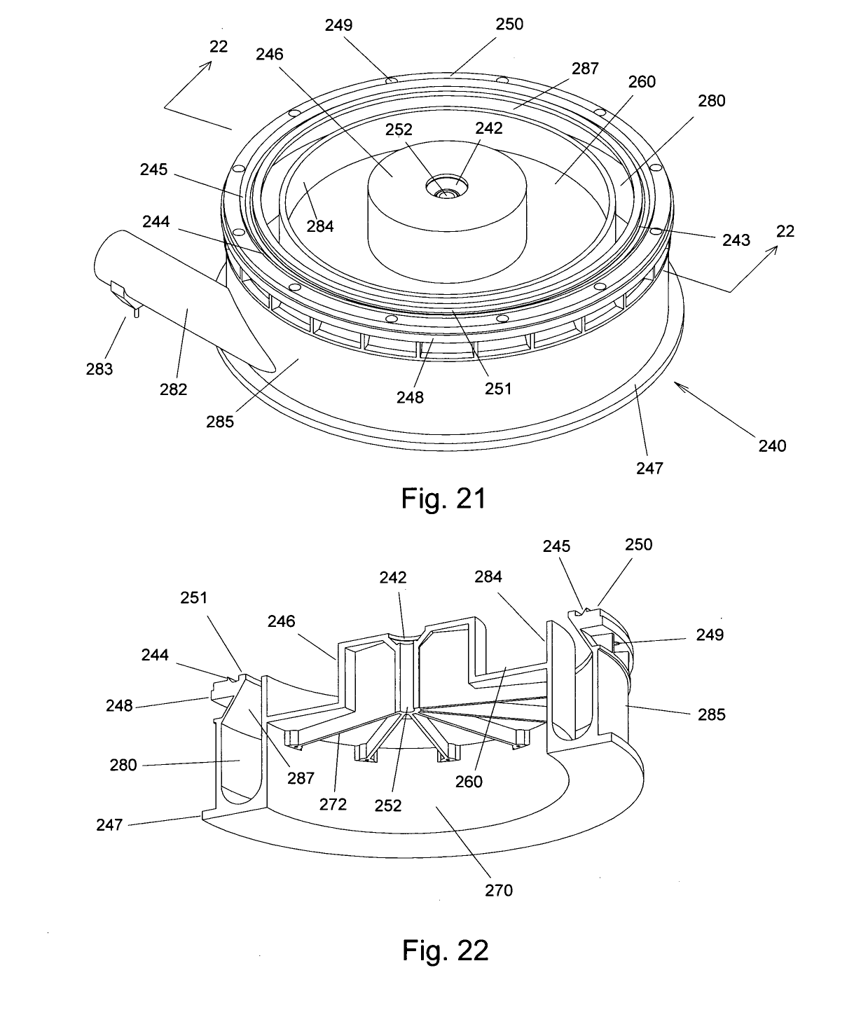

FIG. 21 is an isometric view of the engine base, 240. FIG. 22 is a cut view of the engine base from below the radial plane. Vapor-barrier bearing, FIG. 10, 241, seats on bearing rim, 243. The bearing cage abuts the outer-radius, vertical surface of annular discharge extension, 251. A conforming recess in the nozzle wheel moves rotatably over the upward emanating discharge ring extension. The lower lip of deflection wall, FIG. 10, 838, extends into the inner-radius vertical annular surface of the extension. Exhausted byproduct is deflected downward into byproduct discharge passage, 287, of byproduct reservoir, 280. The outer-radius wall of the passage inclines inward with increasing elevation, and extends the deflection path downward into the reservoir. The byproduct reservoir is an integral part of the engine base. The collection reservoir is defined by outer-radius wall, FIG. 22, 285, an inner-radius wall, 284, and a reservoir floor. The reservoir floor extends radially outward beyond the outer-radius wall where it forms engine-mounting flange, FIG. 21, 247. Reservoir clean-out pipe, 282, provides a means of periodically removing accumulated byproduct. Any fuel seepage entering the reservoir settles in drain, 283.

In the region between the vapor-barrier bearing and stator-ring mating surface, 250, the annular profile of the engine base is conical. Here, condensation slinger surface, FIG. 10, 835, of the nozzle wheel moves over inverted conical surface, FIG. 22, 245. Rotation expels condensate that collects within the narrow gap. The stator ring abuts a vertical lip, FIG. 21, 244. The bosses of fastener seats, FIG. 17, 221, of the stator ring, insert into aligning recesses, FIG. 21, 249, in the engine base. Lower-bearing pedestal, 246, inserts into a recess emanating upward around the center of the nozzle wheel. Tapered roller bearing, FIG. 3, 402, seats in bearing seat, FIG. 21, 242. Lower axle, FIG. 20, 570, turns in axle passage, FIG. 22, 252. Exhaust manifold sections, FIG. 2, 203 and 204, rests on rim, FIG. 21, 248. Induction circuit magnets, FIG. 3, 261 and 262, mount in generator housing, FIG. 22, 260. The floor is supported by an array of radial trusses, 272, which add rigidity to the lower-bearing pedestal and axle passage.

An electric motor-generator might mount in recess, 270, that emanates upward from the bottom of the engine base. The motor-generator would start and maintain rotation. As thrust is produced in the steam nozzles, torque supplied by the motor is reduced. If excess thrust were produced, the motor-generator would produce additional electricity. An alternate embodiment might have a clutch mechanism in the cavity. The clutch joins the electrochemical engine to an electric motor that might turn the wheels of a vehicle. During startup, the electric motor rotates the electrochemical engine. After startup the clutch disengages and the electrochemical engine supplies electricity to the motor. The electric motor might be part of a hybrid power train.

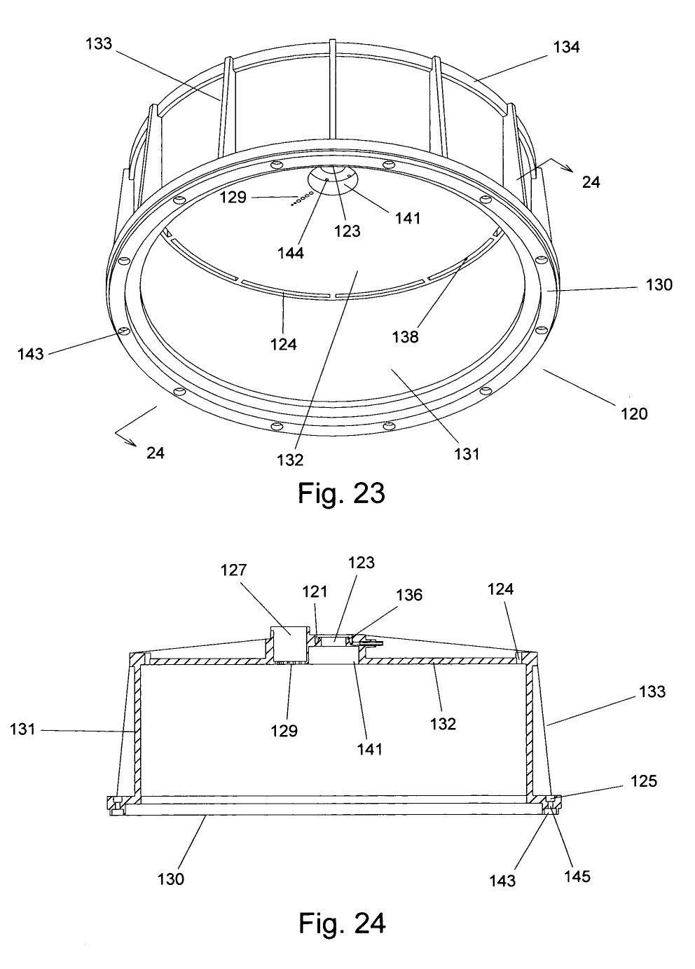

FIG. 23 is an isometric view from below the radial plane of the engine cowling, 120. Recesses, 143, emanate upward from cowling base flange, 130, and align with the bosses of the stator ring. Armature brushes extend downward through armature brush passages, 129. The brush passage design is for a cowling constructed of PPS or similar material having a high dielectric strength. If a metal cowling were used the brush passages would have one or more inserts providing electrical insulation from the surrounding metal. Gas return inlet galley, 138, opens into an air inlet, 124. Bearing collar, FIG. 2, 139, inserts into recessed seat, FIG. 23, 141. Upper axle, FIG. 20, 510, turns in axle passage, FIG. 23, 123.

FIG. 24 is a sectioned view of the engine cowling. The section is through the mid-line of the armature brush cavity, 127, and armature brush passages, 129. The section view reveals fuel overflow trough and drain, 121, that surrounds upper axle passage, 123. Fuel-slinger seal, FIG. 2, 521, seats in groove, 136. A small bearing seal might be substituted for the fuel-slinger seal.

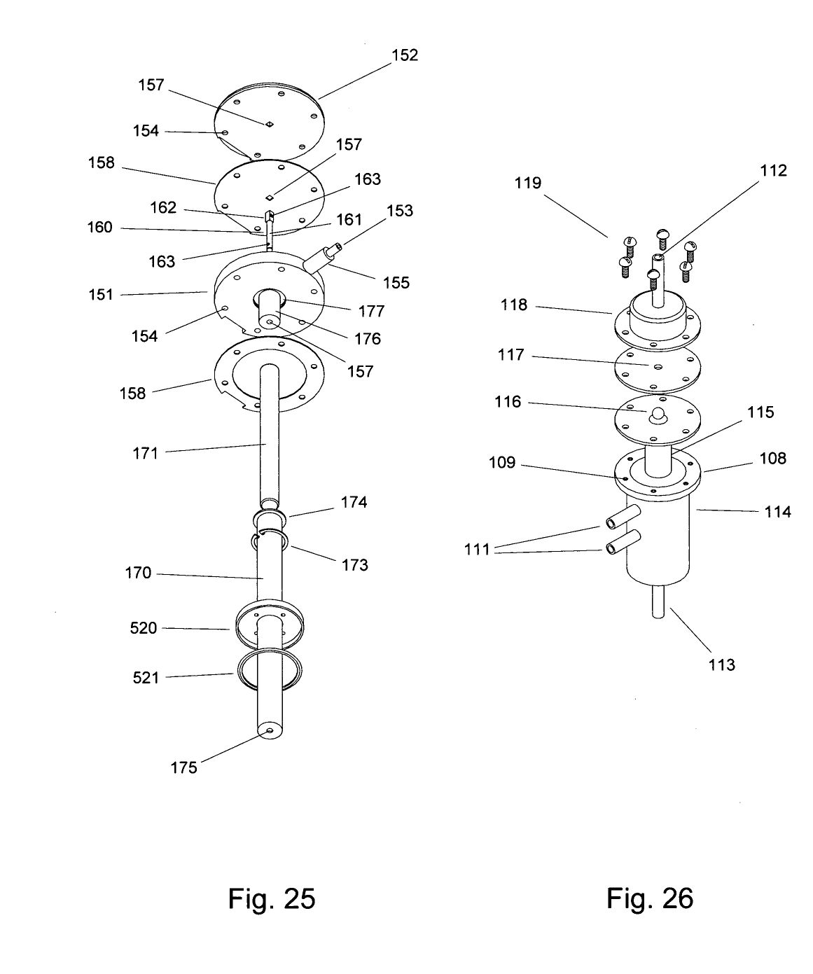

FIG. 25 is an exploded view of the fuel inlet. Float tube flange, 174, at the top of float tube, 170, inserts into seat, 177, in fuel inlet body, 151. Retainer ring, 173, snaps into a groove in the float tube seat and secures the tube to the fuel inlet body. Fuel float, 171, travels freely inside the float tube. Fuel exiting needle valve, 160, enters the float tube. As buoyancy raises the fuel float, float tube drain, 175, is unblocked and fuel flows into the fuel inlet reservoir, FIG. 19, 511. The needle valve has a polygonal upper body, 162. Cylindrical tube, 161, extends from the base of the polygonal upper body and slides vertically in passage, 157, that extends through float-tube guide, 176, of the fuel inlet body. When the fuel float rises, the needle valve is pushed upward into fuel inlet cap, 152, and stops the flow of fuel through the needle valve. An alternate embodiment might have an interrupter switch that seats in the fuel inlet cap. A circuit supplying current or a ground to an electrically powered fuel pump that supplies fuel to the engine would pass through the switch. When the fuel float pushes the needle valve upward into the fuel inlet cap, the needle valve activates the interrupter switch and circuit continuity for the fuel pump is broken. Fuel pumping ceases until the needle valve drops away from the switch.

FIG. 26 is an exploded view of the liquid/gas separator. Threaded fasteners, 119, secure separator cap, 118, to reservoir body, 114. The fasteners secure to fastener seats, 109, in flange, 108. Float tube, 115, inserts into the reservoir, and ball float, 116, travels within the tube. A small separation between the base of the float tube the reservoir floor keeps the float ball inside the tube, while allowing liquid to drain. Float-valve seat, 117, restricts upward movement of the float. When liquid fills the reservoir, the float rises and seats against the bottom surface of the valve seat, thereby stopping liquid from entering the upper chamber in the separator cap. A carbon-cake filter might fill the upper gas chamber.

The low profile, compact embodiment presented herein assumes an elevated rate of hydrogen permeation compared to prior art. Elevated permeation depends on limiting interstitial movement through the membrane lattice to a preferred direction. Assorted forces and other means described herein facilitate such permeation. Opposing movement in three dimensions is expressed by six vectors. When one vector is the preferred direction, restriction of movement reduces six degrees of freedom-of-movement to one. A design must reflect the crystalline structure of the membrane used. A bcc structure has eight possible moves between adjacent interstices. The lattice can be orientated so that only two of the eight moves have radial vector components. In that instance, a hydrogen atom has a 25% chance of moving into one of the two preferred interstices. Application of forces and other means, described herein, that facilitate movement in the desired directions can increase the otherwise random permeation by four times. The same structure can also be orientated so that four of the eight moves have a radially outward vector component. In this second instance, a hydrogen atom has a 50% chance of moving into one of the four preferred interstices. Favored interstitial movement increases the permeation rate for this orientation by only two times. On average, favored movement through the bcc crystal can increase hydrogen permeation by about three times. Consequential reduction of the interstitial hydrogen concentration increases the number of unoccupied interstices in the preferred direction, further elevating the rate at which hydrogen permeates through the ion-pump membrane when compared to the permeation of prior art.

Ultrasound frequency, wavelength and intensity, the ion-pump charge, false-anode shape, membrane composition, permeation surface area and thickness, and tensile stress and radial acceleration induced by angular speed provide a wide mix of design parameters that can be manipulated in alternate embodiments to balance cost, performance, and durability objectives. Alternate embodiments derived by varying such design parameters, and others including, but not limited to the air-to-fuel ratio, fuel inlet, axial-flow fan, induction and other electrical circuits, gas-expansion nozzles, as well as alternative patterns or directions of process flow, are foreseen and thusly included in this invention.

### PATENTS REVIEWED BUT NOT CITED IN SPECIFICATION

U.S. Pat. No. 5,409,784, Apr. 25, 1995, Bromberg et al.
U.S. Pat. No. 6,580,191 B2, Jun. 17, 2003, J. A. Lennox
U.S. Pat. No. 6,656,616 B2, Dec. 2, 2003, Boneberg et al.
U.S. Pat. No. 6,635,377 B2, Oct. 21, 2003, K. Hinokuma
U.S. Pat. No. 5,709,961, Jan. 20, 1998, Cisar et al.
U.S. Pat. No. 6,479,178 B2, Nov. 12, 2002, S. A. Barnett
U.S. Pat. No. 6,730,424 B1, May 4, 2004, He et al.
U.S. Pat. No. 3,180,762, Apr. 27, 1965, H. G. Oswin
U.S. Pat. No. 3,291,643, Dec. 13, 1966, H. G. Oswin
U.S. Pat. No. 6,800,392 B2, Oct. 5, 2004, Jantsch et al.
U.S. Pat. No. 3,847,670, Nov. 12, 1974. C. I. Johnsen
U.S. Pat. No. 3,409,471, Nov. 5, 1968, F. V. Sturm and G. Richter
U.S. Pat. No. 6,203,676 B1, Mar. 20, 2001, Phillips et al.
U.S. Pat. No. 7,005,204 B2, Feb. 28, 2006, Aoyagi et al
U.S. Pat. No. 3,544,380, Dec. 1, 1970, A. N. Dey
U.S. Pat. No. 6,921,595 B2, Jul. 26, 2005, Clawson et al.
U.S. Pat. No. 6,884,528 B2, Apr. 26, 2005, Lee et al.
U.S. Pat. No. 6,815,102 B2, Nov. 9, 2004, Bowman et al.
U.S. Pat. No. 6,312,843 B1, Nov. 6, 2001, Kimbara et al.
U.S. Pat. No. 6,213,234 B1, Apr. 10, 2001, Rosen et al.
U.S. Pat. No. 5,968,680, Oct. 19, 1999, Wolfe et al.
U.S. Pat. No. 4,879,189, Nov. 7, 1989, D. J. Snopkowski
U.S. Pat. No. 5,678,647, Oct. 21, 1997, Wolfe et al.
U.S. Pat. No. 6,759,153 B1, Jul. 6, 2004, Lamm et al.
U.S. Pat. No. 6,896,988 B2, May 24, 2005, Wang et al.
U.S. Pat. No. 4,743,516, May 10, 1988, Noguchi et al.
U.S. Pat. No. 6,338,912 B1, Jan. 15, 2002, Ban et al.
U.S. Pat. No. 6,284,397 B1, Sep. 4, 2001, R. H. Barton
U.S. Pat. No. 1,443,091, Jan. 23, 1923, C. Petersen
U.S. Pat. No. 3,527,617, Sep. 8, 1970, R. Prober
U.S. Pat. No. 4,491,624, Jan. 1, 1985, Sarbacher et al.
U.S. Pat. No. 4,521,497, Jun. 4, 1985, P. J. Tamminen
U.S. Pat. No. 2,960,314, Nov. 15, 1960, A. G. Bodine, Jr.

What is claimed,

1. An electrically charged device that produces a stream of unbalanced ions that transit from one electrode surface to a region adjacent to a second electrode surface; said device being an ion pump,
in which one electrode is a hydrogen-permeable cathodic membrane and the second electrode is a hydrogen-permeable anodic membrane,
in which the cathode and the anode are separated by and secured around the perimeters thereof by a dielectric frame that, together with said cathode and said anode, form a closed water-tight vessel,
in which, in the interior between said cathode, said anode, and said dielectric frame, is disposed one or more false anodes made of a conductor or semiconductor material, each said false anode being fixed in a place that is unique to that false anode,
in which the two-dimensional shape of a cross-section through said false anode resembles a parabola; the vertex being nearest said cathode and the termini of the legs of said parabola being nearest said anode, but where the legs of said false anode might not follow a parabolic curve, but become straight or nearly straight members, that radiate from a curvature through said. vertex, at an angle greater than zero degrees but less than ninety degrees measured from the otherwise parabolic axis,
in which said curvature near said vertex of said cross-section through said false anode presents a large, electrically attractive surface disposed near said cathode, when compared to the sum of the electrically attractive surfaces of the legs of said false anode disposed near said anode, and where said curvature might not follow a parabolic curve from said vertex, thereby increasing the attractive surface area,
in which each said false anode is encapsulated in an insulating material or materials having high dielectric strength, having little to no reactivity to various ions in aqueous solution, especially hydroxide ions, and having a low dielectric constant,
in which said encapsulating insulation progressively decreases in thickness, when measured from the exterior surface of said insulation to the nearest surface of said false anode encapsulated therein, with a decrease in distance to said anode, thus being thickest nearest said cathode and becoming progressively thinner nearer to said anode, notwithstanding insulation that might be disposed in the region between said legs of said false anode viewed in cross-section,
in which the exterior surface of said insulating material encapsulating each said false anode is separated by a distance from the exterior surfaces of said insulation encapsulating any adjacent false anodes, and from said cathode and said anode surfaces, notwithstanding limited areas of contact with the electrode surfaces,
in which the voids formed between said encapsulating insulation of said false anode or false anodes and said cathode, said anode, and said surrounding dielectric frame is filled with water or other solution which might include an antifreeze,
in which said false anode or false anodes are electrically connected to one or more insulated bus bars that at one or more places pass through said dielectric frame without causing leakage of the fluid contained within said ion pump, thus allowing electrical connection of said false anode or false anodes to an electrical circuit or circuits outside said dielectric frame,
in which negative charge (electrons) is transferred from said false anodes through said bus bar or bus bars, and negative charge is transferred to said cathode where water or other said solution is reduced and hydrogen is absorbed into said cathodic membrane,
in which the amount of charge transferred from said false anode or false anodes and the amount of charge transferred to said cathode determines the approximate number of unbalanced anions between said cathode and said anode,
in which the amount of charge on said false anode determines in part the field strength of an attractive force acting between mobile anions in said ion pump and the outer facing surface of the positively charged false anode, said false anode being held in a fixed position between said cathode, said anode, and said dielectric frame,
in which a vector, representing the attractive force acting between a mobile anion in the fluid-filled interior of said ion pump and the nearest surface of a false anode and passing through said insulation encapsulating that false anode surface, can be resolved into two normal vector components such that one vector component is in a direction toward said anode and along the exterior surface of said insulation between said mobile anion and the false-anode surface to which the attractive force vector points, such that the mobile anion moves along the insulating surface toward said anode as do other mobile anions present within said ion pump that are attracted to a false anode surface,
in which mobile anions are attracted around a corner curvature of the exterior surface of said insulation encapsulating the terminus, viewed in cross-section, of a leg of said false anode disposed near said anode, and into a narrow fluid-filled region disposed between said insulation encapsulating said false anode and the anode surface, where the exterior surface of said insulation encapsulating said false anode is generally parallel to said anode surface,
in which movement of anions toward said anode and encircling the insulated false anode, and the progressive change in the thickness of said insulation encapsulating said false anode, produces a changing density of mobile anions surrounding said insulation, said density increasing in the direction toward said anode, such that mutual repulsion according to Coulomb's law between adjacent anions surrounding said false anode is greater nearer said anode and lesser nearer said cathode,
in which mobile anions entering said narrow fluid-filled region disposed between said insulation encapsulating said false anode and the anode surface are closer to said anode surface than the positively charged surface of said false anode or false anodes,
such that when activated by work, anions that have migrated from said cathode to the narrow fluid-filled region adjacent to said anode combine with hydrogen that permeates through said anodic membrane, the reaction of said anions and hydrogen producing an imbalance of electric charge between the remaining anions and said false anode or false anodes,
said reaction of said anions and hydrogen releasing exothermic enthalpy, thereby raising the internal energy of the fluid within the interior of said ion pump,
said imbalance of electric charge between the remaining anions and said false anode or false anodes and said large, electrically-attractive false anode surface near said cathode and the lower surface density of anions nearer said cathode, together drawing conducting electrons from said anode through an external circuit to said cathode,
and the increase in internal energy of the water or other solution within said ion pump and the transfer of charge (electrons) from said anode to said cathode, causing the reduction of water molecules at the cathodic membrane surface to hydrogen and hydroxide ions and the absorption of hydrogen ions into said cathodic membrane, thereby producing unbalanced anions that migrate toward said false anode or false anodes to restore the balance of electric charge between said anions and said false anode or false anodes,
so that, at an operating equilibrium, a balanced flow of unbalanced mobile anions flowing from said cathode toward said anode and conducting electrons in said external circuit flowing as an electrical current from said anode toward said cathode, does useful work.

2. The device in claim 1 where said ion pump has various embodiments including but not limited to rectilinear forms having cathode and anode plates that lie in flat planes, or curved forms where a cross-section in the plane of an axis-of-revolution and passing through said dielectric frame, said cathode, said anode, and each of said one or more false anodes and encapsulating insulation, is revolved about said axis-of-revolution to produce arc-segment or fully-revolved ion pumps, and, in the case of revolved embodiments, where the orientation of said false anodes and said encapsulating insulation might be varied by up to ninety degrees such that said false anodes and said encapsulating insulation might not be revolved elements, instead extending between two radial planes of the revolved embodiment that describe interior surfaces of said dielectric frame, or where the shape of said false anodes might have embodiments other than that resembling a parabola so long as such alternate shapes serve the purpose of causing a stream of unbalanced ions to transit from one electrode surface to a region near a second electrode surface.

3. The device in claim 1 where a projection emanating from said insulation encapsulating said false anode extends to the interior surface of said anode, thereby forming a narrow bridge that extends across said narrow fluid-filled region between said insulation encapsulating said false anode and the anode surface in a manner that prevents hydrogen molecules that form at the interior surface of said anode from rising beyond said narrow bridge when a buoyant force is in the general direction from the terminus of one said false anode leg, viewed in cross-section, to the terminus of the other false anode leg.

4. The narrow bridge in claim 3 transmitting vibration from said anode into said insulation encapsulating said false anode and from said insulation into the fluid within said ion pump, the vibration agitating anions at or near the surface of said insulation forming said narrow fluid-filled region between said insulation and the anode surface, and where said insulation might have a gas-filled cavity inside said insulation, the cavity being disposed in the region between the termini of the legs of said false anodes, viewed in cross-section, and below the surface of said insulation adjacent to said narrow bridge, said cavity permitting greater deflection of the surface of said insulation, which increases vibration of the surface of said insulation that forms said narrow fluid-filled region, and said cavity might resonate and amplify the vibration.

5. The device in claim 1 where said false anode has one or more added conducting members disposed between the legs of said false anode viewed in cross-section, and affixed to at least one leg of said false anode, said added conducting member or members being fixed at a distance and angle from said anode surface so that when said false anode is electrically charged, the aggregate of the combined surfaces of said added conducting member and said legs of said false anode when surrounded by said unbalanced anions, and their distances from said anode surface have an electrical attraction to said anode surface that is less than the electrical attraction between said curved surface near said vertex of said false anode and said cathode surface, said difference in electrical attraction being necessary for the transfer of charge from said anode to said cathode, said added conducting member attracting anions encircling the insulation around one or both termini of said legs of said false anode, into the narrow fluid-filled region disposed between said insulation encapsulating said false anode and the anode surface.

6. The device of claim 1 where a revolved anode surface, as described in claim 2 above, inclines toward the axis-of-rotation of a centrifuge, thereby resembling a truncated, conic-shell segment, such that if rotated, the incline of said anode surface produces a radial-acceleration, force component that lies parallel to said anode surface facing said axis-of-rotation, and in the direction opposite from the inward incline toward said axis-of-rotation, and having an angle of incline that is sufficiently large to prevent dense matter accelerated against said anode surface from staying at one position, instead moving along said inclined anode surface and away from said axis-of-rotation when the device in claim 1 is rotated about the axis.

7. The device in claim 1 where the polarity of the ion pump and direction of flow might be reversed from that described such that cations are attracted to a negatively charged false cathode thereby producing a stream of cations that transit from an anode surface to a region adjacent to a cathode surface.

8. The device of claim 1 providing a means of balancing anion flux within the ion pump to the rate that hydrogen permeates through said anodic membrane by adjusting the charge applied to said false anode(s), changing the angle of divergence of said legs of said false anodes viewed in cross-section, and/or adjusting the speed of rotation which produces a buoyant force.

9. The device of claim 1 having a vibrating surface disposed a distance from the anode surface facing away from said false anode or false anodes of said ion pump, the vibrating surface adding activation energy to dehydrogenate hydrogen-containing fuel at the anode surface of said ion pump, the combination of said ion pump and vibrating surface being an activation cell,
in which said vibrating surface lies generally parallel to said anode surface, whether said anode surface is planar or curved,
in which said vibrating surface and said anode surface of claim 1 form a narrow void disposed between both said elements, said void being a fuel vessel, such that if rotated as described in claim 6, said anode bounds said fuel vessel at the outer radius thereof and said vibrating surface bounds said fuel vessel at the inner radius thereof,
in which liquid, hydrogen-based fuel, including liquid hydrocarbons, fills said fuel vessel, and in which fuel inside said fuel vessel might be accelerated against said anode surface, said acceleration being caused by gravity, or specifically pertaining to claim 6, being caused by centrifugal acceleration produced by rotation about a spin axis,
in which periodic oscillation of said vibrating surface produces pressure waves through the fuel medium, that impinge against said anode surface and are, in part, reflected back,
in which the distance separating said vibrating surface from said anode surface is an integer multiple of a half wavelength of said pressure wave produced by said periodic oscillation of said vibrating surface, where the wavelength is determined by the speed of sound in the fuel medium at a chosen frequency, such that said vibrating surface might produce a standing wave in the fuel medium that builds in intensity,
in which the frequency of oscillation of said vibrating surface is a multiple equal to or greater than a corresponding, average rate of hydrogen absorption into each absorbing site of said anodic and/or cathodic membrane surfaces for a specified rate that fuel is dehydrogenated,
in which the maximum pressure amplitude, at the frequency used to produce a desired hydrogen permeation through said anodic and cathodic membranes, is such that the pressure amplitude and frequency together supply the energy intensity necessary to transfer hydrogen from said hydrogen containing fuel to said anode surface, at a specified flow rate of the liquid fuel,
in which pressure waves produced by said vibrating surface are transmitted through said anode of said ion pump, thereby producing vibration or cavitation within said ion pumps, such that the vibration or cavitation agitates unbalanced anions surrounding said insulation encapsulating said false anode and causes anions to move toward the anode surface,
in which covalent bonds between carbon and hydrogen atoms of a hydrocarbon molecule increase the electron cloud density between the carbon and hydrogen atoms thereof, and produce a positive, but non-polar bias surrounding the hydrocarbon molecules of the fuel filling said fuel vessel and bearing against said anode surface, and in which the negative charges of unbalanced anions within said ion pump are close to said opposite anode surface, together said fuel and said anions, when agitated by said pressure waves, inducing a surface bias across said anode that is favorable to hydrogen adsorption and absorption at the anode surface facing into said fuel vessel and hydrogen desorption at the anode surface facing into said ion pump,
in which activation energy, that is added by said vibrating surface to dehydrogenate said hydrogen-containing fuel at said anode surface, indirectly supplies energy to reduce water to hydrogen and hydroxide ions at the interior cathode surface of said ion pump, by a process in which exothermic enthalpy that is subsequently released into the water within said ion pump as anions therein combine with hydrogen emerging from said anodic membrane, adds endothermic enthalpy for the corresponding reduction of water or other solution at the cathode surface, such that the sum of endothermic enthalpies of formation of the reaction products approximates the activation energy added by said vibrating surface to the liquid fuel to dehydrogenate the fuel,
in which said vibrating surface produces ultrasonic waves through the fuel medium filling said fuel vessel in a manner such that the wave motion prevents or limits deposition of carbon at said anode surface, including said inclined anode surface of claim 6 above,
and in which said vibrating surface is the outer surface of an electrostrictive (piezoelectric) or magnetostrictive transducer material that functions as a resonator, or is another material that is directly or indirectly attached to the resonator, said resonator being connected to a circuit that causes oscillation at the desired frequency and pressure amplitude.

10. A means of increasing the transmission of hydrogen through a hydrogen-permeable membrane while reducing the hydrogen concentration therein, by facilitating movement between adjacent interstices of the membrane lattice in the general direction of said transmission, while restricting movement through the membrane lattice in other directions,
by applying tensile stress across the surface of the host membrane in a manner, where said tensile stress favors lengthening bonds of the crystalline lattice of the host membrane in directions that are generally normal to a desired direction of movement of hydrogen through the host membrane, thereby increasing interstitial mobility of hydrogen in said desired direction, and favors shortening the bonds of the crystalline lattice of the host membrane in the desired direction of movement of hydrogen through the membrane, thereby decreasing interstitial mobility of hydrogen in directions that are generally normal to said desired direction of movement, where said tensile stress might be produced by rotating the membrane about an offset axis,
by applying a force periodically in a succession of waves propagating through said host membrane that is under tensile stress, the wave causing a brief flexure of interstices within said membrane, as the wave passes said interstices, in a manner that expels or favors expulsion of hydrogen from occupied interstices, where the expulsion is generally anisotropic in said desired direction, and where successive waves occur at a frequency that increases the rate hydrogen permeates through said host membrane,
and by rotating said host membrane about an offset axis in a manner that accelerates hydrogen within interstices of said host membrane, in said desired direction of transmission of hydrogen through said host membrane, and where the direction of said acceleration aligns with, or nearly aligns with the direction of said propagation of waves through said host membrane, such that the combined application of forces expels hydrogen in the desired direction of movement of hydrogen through said host membrane, thereby increasing permeation through said membrane.

11. The means of claim 11 where said succession of waves through said membrane lattice are produced by periodic oscillation of said vibrating surface of claim 9, having the wave intensity to dehydrogenate fuel at said anode surface.

12. The means of claim 11 where facilitating permeation in a preferred direction lowers the interstitial hydrogen concentration, thereby increasing the rate of hydrogen permeation.

13. The means of claim 11 where facilitating permeation in a preferred direction reduces the hydrogen concentration within a membrane, thereby reducing or eliminating precipitation of hydrides of the membrane metal, and the embrittlement and failure caused thereby.

14. A rotating device which secures in place one or more activation cells of claim 9, at a radial distance from the axis-of-rotation of said rotating device, and produces useful work in the form of a turning torque derived from the catalyzed reaction of hydrogen gas, immerging from the cathode of said ion pumps, with atmospheric oxygen, said rotating device and stationary housing being a pumped-ion, electrochemical engine, abridged to electrochemical engine herein,
in which the center of a circular array of two or more arc-segment-revolved ion pumps or the circular center of one fully-revolved ion pump or a stacked array of fully-revolved ion pumps coincides with the spin axis of said electrochemical engine, and where said axis-of-revolution of said arc-revolved ion pump might coincide with the axis-of-rotation of said electrochemical engine; the portion of said electrochemical engine securing in place said activation cell or activation cells being a rotor frame,
in which an axle shaft emanates from the top and bottom of said rotor frame, said axle shaft being at the center of and normal to the radial plane of said rotor frame, being located in said stationary housing and supported by one or more anti-friction bearings that permit rotation of the parts that form the rotating unit of said electrochemical engine, and being hollow at the axial center thereof, with the hollow cavity of the axle hub extending from one terminus of said axle shaft toward, but not to the other terminus of the axle shaft such that the hollow center of said axle shaft forms a fuel-inlet reservoir, which might be cylindrical or polygonal in form,
in which one or more galleys extend from said fuel-inlet reservoir in a generally radially-outward direction to said fuel vessel disposed in each said activation cell in said rotor frame,
in which rotation of said rotor frame of said electrochemical engine causes fuel that flows through said galleys to swirl or be centrifuged against said inner-radius anode surface of each ion pump secured to said electrochemical engine by said rotor frame,
in which rotation of said electrochemical engine causes air or other light gases that might be present in said fuel vessels of said activation cells to be displaced and exhausted from said fuel vessels by denser, liquid fuel that swirls or is centrifuged against said inner-radius anode surface of each ion pump secured to said rotor frame,
in which rotation centrifuges water in said ion pump and produces a buoyancy that might support the migration of unbalanced anions in the direction of movement caused by said false anodes from said cathode to said anode of each said ion pump,
in which rotation produces tensile stress and radial acceleration in said anodic and cathodic membranes of said ion pumps, as said vibrating surface of claim 9 produces pressure waves, such that hydrogen permeation through said membranes is increased in the manner of claims 10, 11 and 12, and said membranes are preserved in the manner of claim 13,
in which rotation of said electrochemical engine adds energy to the airflow entering a fan that is part of the rotating unit of said electrochemical engine,
in which turning torque is derived by the exothermic reaction of hydrogen exhausted by said cathodic membrane of each said ion pump secured in said electrochemical engine with atmospheric oxygen in the energized airflow exiting said fan, in a gas expansion device, such as divergent nozzles, a gas turbine, a piston and crankshaft assembly, or an offset rotor movement,
in which said turning torque of said electrochemical engine is used to turn said fan that is part of said rotating unit, and to generate electricity to charge said false anodes of said ion pumps and power said ultrasound transducers and other electrically actuated devices that are part of said electrochemical engine, where the means of generating and transmitting electricity to the devices might be part of said rotating unit of said electrochemical engine,
in which hydrogen-depleted carbon byproduct from hydrocarbon fuel dehydrogenated in said activation cells is first collected, centrifuged and ejected by said electrochemical engine, and the ejected byproduct is collected in a reservoir, such that collection of hydrogen-depleted, carbon results in no carbon dioxide gas being produced from the carbon that is collected in said reservoir, and thereby not entering the atmosphere as a greenhouse gas, as hydrocarbon fuel is converted to electricity and turning torque by said electrochemical engine,
and in which hydrogen-depleted carbon byproduct that is collected in said reservoir can be periodically removed from said electrochemical engine through an access channel or portal, such that said byproduct might be recycled into an economical reuse.

15. The device of claim 14 having a means of producing high-velocity thrust in a circular array of divergent-flow nozzles that are disposed near the outer radius of a nozzle wheel that is affixed to or an integral part of said rotor frame of said electrochemical engine, where the nozzle flow is generally along a chord at the thrust radius of said divergent-flow nozzles and leading to the outer radius of said nozzle wheel, where said nozzle flow is in a direction that is generally anti-parallel to the rotation of said nozzle wheel, and where the design curvature of each said nozzle passage is such that, as said nozzle wheel rotates at constant, design-angular-speed, the interior walls of each said divergent nozzle passage coincide with mathematical, area-ratio boundaries for the changing supersonic velocity of a differential element of compressible fluid as it travels along said chord to the nozzle exit at said outer radius of said nozzle wheel, said nozzle wheel being encircled by a stator ring, where the angles of surfaces forming passages between the vanes of said stator ring, align with the direction of the gas flow at the exits of said divergent nozzles.

16. The assembled parts that make up the rotating elements of the device of claim 14 producing little to no aerodynamic drag, by a means in which the combined exterior surfaces of said rotating elements, excluding the fan inlet and nozzle exhausts, are cylindrical in form with the cylinder axes aligned with the axis-or-rotation, such that the surfaces of the assembled rotating unit are aerodynamically smooth and constant in the direction of rotation of the electrochemical engine, as said rotating unit turns within the interior of the stationary housing.

17. The device of claim 14 having one or more solenoid-actuated exhaust valves that operate with a counterweight mechanism such that said counterweight movement provides a means of reducing the solenoid pulling force and the size of the solenoid coil, and where the movement of said counterweight contemporaneously closes the entrance into a sump where denser hydrogen-depleted fuel byproduct is separated from fuel by centrifuging, while it pushes said centrifuged hydrogen-depleted fuel byproduct toward an exhaust port, as said solenoid-actuated valve opens said exhaust port and exhausts hydrogen-depleted fuel byproduct into a collection reservoir.

18. The device of claim 14 having a means of sealing against leakage said combined device of claims 9 that make said activation cell, said means using pressure to compress said flexible diaphragm adjoined to said vibrating surface, the perimeter of said diaphragm being secured between opposing mating surfaces of said dielectric frame of said ion pump and the housing of said vibrating surface, resonator, internal circuits and mounting hardware, where said opposing mating surfaces form an inclined plane dividing said activation cell, and the mating surfaces can slide slightly with respect to each other, where, with said dielectric frame slightly moved along said inclined plane of said activation cell, said activation cell snuggly slides into a matching slotted cavity disposed in said rotor frame, where said slotted cavity is open at one end in a radial plane of said rotor frame and is closed at the opposing end of said rotor frame, where said matching slotted cavity restricts radial movement of said activation cell inserted into said rotor frame, such that as pressure is applied by an abutting retainer against the surface of said activation cell disposed at the open end of said rotor frame, said dielectric frame is forced by the abutting retainer to slide along said incline with respect to said transducer housing, the sliding movement causing radial expansion of said activation cell that is opposed by the confining walls of said slotted cavity of said rotor frame, and thereby compressing said flexible diaphragm between the opposing mating surfaces of said dielectric frame of said ion pump and the housing of said vibrating surface, resonator, internal circuits and mounting hardware, said retainer abutting said activation cell being secured to or through said rotor frame by threaded fasteners that cause and increase pressure against said dielectric frame as said threaded fasteners are tightened in place, and where the increase in pressure also compresses gaskets that seal the fuel passage and byproduct discharge passage leading into and from said dielectric frame.

19. The device of claim 14 having a means of controlling fuel flow into said fuel-inlet reservoir of said electrochemical engine by a fuel float that travels inside a float tube that remains stationary relative to the rotation of said electrochemical engine, said float tube inserting into the spinning fuel-inlet reservoir disposed in said axle hub, and having a fuel outlet disposed at the base of said float tube which reduces fuel swirl present within said float tube, and where said fuel float traveling within said float tube moves a valve, such as a needle valve, that controls fuel flow.

20. The device of claim 14 having one or more electronic control modules that are disposed within said rotor frame, where said electronic control module might contain but is not limited to transformer circuits, rectifier circuits, ultrasound oscillator circuits, capacitive discharge circuits to power said solenoid-actuated exhaust valves, timing circuits, and switches, with one or more switch being electrically actuated to allow the voltage and current output from pairs of ion pumps up to the aggregate of all ion pumps disposed in said rotor frame to be varied between series and parallel interconnections while said electrochemical engine is turning, and where a variety of outputs and signals to and from said electronic control module or electronic control modules are transmitted through slip rings, electrically connected to said control modules, and armature brushes, said armature brushes being easily accessible for regular maintenance.

21. The device of claim 14 having a gear, pulley wheel, clutch assembly or other similar device, connected to the axle emanating from said rotor frame, said gear, pulley, clutch assembly or other device permitting temporary mechanical connection of said electrochemical engine to an electric motor that turns the wheels of a vehicle, where the temporary connection to said electric motor supplies startup rotation of said electrochemical engine, which after startup disengages from said electric motor and thereafter supplies electricity to the electric motor that turns the wheels of the vehicle, including where said electric motor might be connected to an internal combustion engine in the manner of hybrid power train used in a vehicle.

22. Any device that incorporates one or more of the devices and means of claims 1 through 14 as part of a process that produces useful work, and in which hydrocarbon fuel is dehydrogenated at one or more electrode surfaces and the hydrogen-depleted carbon byproduct of the fuel is collected and saved for economical reuse, thereby not exhausting the collected carbon as carbon dioxide or carbon monoxide into the atmosphere as a greenhouse gas during the process of converting the hydrocarbon-based fuel into work.
